(19) United States
(12) Patent Application Publication
(10) Pub. No.: US 2025/0180962 A1
(43) Pub. Date: Jun. 5, 2025

(54) OPTICAL-PARAMETRIC-AMPLIFICATION-ENHANCED SPECTROSCOPY AND SENSING

(71) Applicant: California Institute of Technology, Pasadena, CA (US)

(72) Inventors: Alireza Marandi, Pasadena, CA (US); Mingchen Liu, Pasadena, CA (US); Robert M. Gray, Pasadena, CA (US)

(73) Assignee: California Institute of Technology, Pasadena, CA (US)

(21) Appl. No.: 18/963,045

(22) Filed: Nov. 27, 2024

Related U.S. Application Data
(60) Provisional application No. 63/603,013, filed on Nov. 27, 2023.

(51) Int. Cl. G02F 1/39; G01J 3/42; G02F 1/35; G02F 1/355; H01S 3/00

(52) U.S. Cl. CPC G02F 1/392; G01J 3/42; G02F 1/3548; G02F 1/3558; H01S 3/0057

(57) ABSTRACT

A device useful as a spectrometer or a sensor, comprising a source of a short electromagnetic pulses at a first wavelength and having a full width at half maximum in a range of 1 femtosecond-1 nanosecond; a sample holder in which the short pulses interact with the sample in the sample holder so as to form an output signal comprising a background residual of the short pulses and a sample response signal in the time domain, and an amplifier comprising nonlinear medium. The nonlinear medium comprises an input for receiving the output signal and a pump pulse at a second wavelength, and a second-order nonlinearity configured for a nonlinear process selectively amplifying the sample response signal, for example by temporally overlapping the pump pulse and the sample response signal.

### CROSS REFERENCE TO RELATED APPLICATIONS

This application claims the benefit under 35 U.S.C. Section 119 (e) of U.S. Provisional Application No. 63/603,013, filed Nov. 27, 2023, by Alireza Marandi, Mingchen Liu, and Robert M Gray, entitled “Optical-Parametric-Amplification-Enhanced Background-Free Spectroscopy,” (CIT-9102-P) which application is incorporated by reference herein.

### STATEMENT REGARDING FEDERALLY SPONSORED RESEARCH AND DEVELOPMENT

This invention was made with government support under Grant No. FA9550-20-1-0040 and FA9550-23-1-0755 awarded by the Air Force and under Grant No. ECCS1846273 awarded by the National Science Foundation. The government has certain rights in the invention

### BACKGROUND OF THE INVENTION

### 1. Field of the Invention

The present disclosure relates to spectrometers and sensors and methods of making and using the same.

### 2. Description of the Related Art

Optical absorption spectroscopy is a powerful and versatile tool to study properties of different materials. The absorption information is typically contained in the change of the radiation source and deciphered by comparison between at least two measurements of the optical spectrum. Detecting trace samples with low concentrations is important and can push the limits of a wide range of applications, such as breath analysis [1], industrial control [2] and environmental monitoring [3]. However, in traditional absorption spectroscopy, detection of tiny absorption dips on top of a large background is a fundamental challenge, which is limited by the noise and stability of the light source, as well as the dynamic range of the whole detection system.

There are some existing background-free spectroscopy (BFS) methods, including photoacoustic spectroscopy [4,5], Faraday rotation spectroscopy [6,7], and laser-induced fluorescence spectroscopy [8]. Nevertheless, they are limited either in access to narrow resonances and quantitative measurement capabilities or only applicable to a small class of molecules and narrow wavelength range. These challenges have limited such techniques to prototypical demonstrations in laboratory settings in contrast to more standard infrared spectroscopy techniques like Fourier transform infrared spectroscopy (FTIR).

Recently, to realize a background-free detection in broadband infrared (ro-vibrational) spectroscopy, two types of approaches have been proposed and demonstrated. The first is temporal gating based on short excitation pulses and nonlinear wave mixing [9-13], in which the excitation background is detected and separated from the free-induction decay signal directly in the time domain. However, time-resolved measurements require not only accurate synchronization (femto- or even atto-second level) and scanning between two independent pulse trains but also super short pulses, which may have to be shorter than one optical cycle of the excitation pulse. These components are challenging to realize and necessitate substantial efforts.

The second is broadband linear interferometry [14-16], which is motivated by LIGO [17], dual-beam interferometry and some narrow band laser absorption spectroscopy works [19,20]. In this approach, a Mach-Zehnder-like or Michelson-like interferometer arranged for destructive interference is used to coherently subtract the background from the optical field using a sign-inverted replica before the optical power arrives at the photodetector, which converts absorption from dips to peaks in spectra.

However, this method is directly limited by the realistic intensity extinction ratio (field unbalanced factor), which necessitates locking and additional components in the setup to control and practically difficult to further decrease. Therefore, the advantage of this BFS method over direct absorption spectroscopy (DAS) is limited to only a ˜10 times improvement in SNR [14,16] and is not experimentally demonstrable in some cases [15].

### SUMMARY OF THE INVENTION

Traditional absorption spectroscopy has fundamental difficulty in resolving small absorbance from strong background due to the instability of laser sources. Existing background-free methods in broadband vibrational spectroscopy help to alleviate this problem but face challenges in realizing either low extinction ratios or time-resolved field measurements. Here, we introduce optical-parametric-amplification-enhanced spectroscopy or sensing, where an amplifier selectively amplifies the sample response signal and sends the amplified signal to a detector or spectrometer for further processing.

In another embodiment, the excitation background is first suppressed by an interferometer and then the free-induction decay that carries molecular signatures is selectively amplified. We show that this method can further improve the limit of detection in linear interferometry by order(s) of magnitude without requiring lower extinction ratios or time-resolved measurement, which can benefit sensing applications in detecting trace species.

Illustrative embodiment include, but are not limited to, the following.

1. A device useful as a spectrometer or a sensor, comprising:
a source of a short electromagnetic pulses at a first wavelength and having a full width at half maximum in a range of 1 femtosecond-1 nanosecond;
a sample holder in which the short pulses interact with the sample in the sample holder so as to form an output signal comprising a background residual of the short pulses and a sample response signal in the time domain,
an amplifier comprising nonlinear medium comprising:
an input for receiving the output signal and a pump pulse at a second wavelength, and
a second-order nonlinearity configured for a nonlinear process selectively amplifying the sample response signal to form an amplified pulse or signal.

2. The device of clause 1 further comprising an interferometer comprising the sample holder and operable to interfere a sign-inverted replica or out of phase replica of the short pulse with the short pulse after interaction with the sample in the sample holder, so as to form the output signal comprising the background residual and the sample response signal.

3. The device of clause 1 further comprising a delay path applying a delay between the first wavelength and the second wavelength at the input of the non-linear medium, and wherein the amplifier characteristics of the nonlinear medium are designed to amplify the sample response signal associated with the temporal features of a specific molecular specie in the sample.

4. The device of clause 3 wherein the delay can be adjusted to different values associated with temporal features of different molecular species in the sample, and the device either scans the first wavelength and/or the second wavelength to span absorption resonances of the species or discretely selects wavelengths associated with the resonances of different ones of the species.

5. The device of clause 1, further comprising a detector coupled to an output of the nonlinear medium, the detector operable to detect the amplified pulse generated by the nonlinear medium and outputting a detection signal in response thereto, wherein the detection signal carries information about the molecular species present in the sample.

6. The device of clause 5, further comprising a spectrometer coupled to an output of the nonlinear medium, in which a measured spectrum of the amplified pulse by the spectrometer carries information about the molecular species present in the sample.

7. A system comprising the device of clause 1, further comprising a computer configured for determining, from a detection signal outputted from a detector in response to the amplified pulse, or an output spectrum of the amplified pulse measured by a spectrometer, one or more species present in the sample and their concentrations.

8. The system of clause 1, wherein the first wavelength is selected to overlap with ro-vibrational spectral features of one or a plurality of the target molecular species in the sample.

9. The device of clause 1, further comprising a circuit for controlling the power of the short pulse at the first and/or the second wavelength, wherein a minimum detectable absorbance of the sample obtained using the amplified pulse is reduced as compared to that obtained from amplification of both the background residual signal and the sample response signal.

10. A control circuit coupled to the device of clause 1, for controlling at least one of a power, a profile, a width, center delay of the pump pulse, or a trade-off between a width and peak power of pump pulse for a fixed average power, to tune a minimum detectable absorbance of the sample for predetermined features in an absorption spectrum of the sample.

11. A control circuit coupled to the device of clause 1, for controlling at least one of a power, a profile, a width, center delay of the pump pulse, or a trade-off between a width and peak power of pump pulse for a fixed average power, such that noise in a detection signal of the amplified pulse by a detector is dominated by detector noise and measurement of absorption of the sample from the detector signal is not limited by relative intensity noise of the short pulse.

12. The device of clause 1, wherein noise of a detector signal outputted from a detector detecting the amplified pulse and minimum detectable absorbance of the sample obtained using the detector signal are in ranges such that a concentration or a composition differentiation of the sample comprising one or more molecules can be determined from the detection signal.

13. An analyzer comprising the device of clause 1, wherein the noise and minimum detectable absorbance are configured for identifying composition and/or concentration of molecules in the sample comprising breath, atmospheric pollutants, greenhouse gas, or a process gas monitored in an industrial setting.

14. The device of clause 1, comprising multiple delay paths configured for setting an overlap of the pump pulse and the sample response signal for different absorption peaks or features in a absorption spectrum of the sample.

15. The device of clause 1, wherein the sample response signals of the sample to the short pulse associated with different absorption features create different delays between the background residual signal and the sample response signals and delays between the between the first wavelength and the second wavelength are selected to temporally overlap the pump pulse with each of the different sample response signals.

16. One or more chips or photonic integrated circuits comprising the device of clause 1.

17. The device of clause 1, wherein the nonlinear medium is quasi-phase matched for the nonlinear process comprising degenerate or non-degenerate optical parametric amplification (OPA).

18. The device of clause 2, wherein the interferometer comprises:
a first arm comprising the sample holder;
a second arm for transmitting a sign-inverted or dephased replica of the short pulse through an optical path length equivalent to that of the first arm without the sample; and
a beamsplitter or coupler coupled to the outputs of the first arm and the second arm for combining the replica and the short pulse after the interaction with the sample.

19. The device of clause 1, wherein the sample holder comprises a cavity for confining the sample comprising a gas or a liquid.

20. A method for performing spectroscopy, comprising:
irradiating a sample with short electromagnetic pulses at a first wavelength and having a full width at half maximum in a range of 1 femtosecond-1 nanosecond; to form an output signal comprising a background residual of the short pulses and a sample response signal in the time domain, and
inputting the output signal and a pump pulse at a second wavelength to a nonlinear medium comprising a second-order nonlinearity configured for a nonlinear process selectively amplifying the sample response signal to form an amplified signal; and
analyzing the amplified signal to determine information about the sample.

### BRIEF DESCRIPTION OF THE DRAWINGS

The patent or application file contains at least one drawing executed in color. Copies of this patent or patent application publication with color drawing(s) will be provided by the Office upon request and payment of the necessary fee

Referring now to the drawings in which like reference numbers represent corresponding parts throughout:

FIG. 1a. Schematic of Optical-parametric-amplification-enhanced spectroscopy and sensing. Optical pulses that are sent to a sample can be sent to an OPA. The OPA is designed in a way that the pump pulses amplify a specific portion of the absorbed pulses, for instance the FID of a specific molecule or multiple molecules by precisely choosing the relative delay and pulse lengths of both the initial pulse and the pump pulse. The OPA output is the dominantly carrying out the information about the absorption signal, which can be either sent to a spectrometer or a proper photodetector for sensing the targeted molecule.

FIG. 1b. Schematic of Optical-parametric-amplification-enhanced background-free spectroscopy (OPA-BFS). (a) short pulse generation. BPF: bandpass filter. BPF and pulse shaper may be required to change and control the profile and pulse width of the original pump pulse because the short-pulse OPA in (c) may need a pump pulse with a longer pulse width and a different profile. (b) Linear interferometry. While a Michelson-like interferometer is illustrated here, a Mach-Zehnder-like interferometer can also work. For clarity, we only present the most important components of the interferometer; more details, especially regarding dispersion compensation and delay locking, can be found in Ref [14-16]. Note that we make a very short and clean separation between the excitation pulse (center) and FID radiation for clarity of the illustration, which is not always the case in practice. However, this will not influence our following analysis and arguments, as there will always be part of the FID radiation that is far enough from the excitation pulse center and thus can be separated well. (c) Short-pulse OPA. Here, we show the illustration of an OPA based on nanophotonic periodically-poled lithium niobate (PPLN)

FIG. 2. Qualitative comparison between different spectroscopy schemes. (a) DAS. (b) Ideal (linear) BFS. (c) Ideal BFS followed by an ideal general frequency-domain amplifier (GA). (d) Real BFS. (e) Real BFS followed by a GA. (f) Real BFS followed by a short-pulse OPA.

FIG. 3. OPA-BFS for a mock sample. (a) Intensity (absorbance, red solid curve) and phase (blue dashed curve) of 11 Lorentzian transitions assumed for the mock sample. (b) FID field of the signal pulse (red curve, left y-axis) that probed the sample in the interferometer (see “Arm 1” in FIG. 1(b)). Note that, to show the weak and long FID, the y scale (intensity) is zoomed in and x scale (time) is zoomed out: therefore the stronger and narrower background residual (blue curve) cannot be seen clearly here. The yellow curve (right y-axis) denotes the envelope of the pump pulse. (c)-(f) Spectral noise level (blue dotted curves) and ideal absorption signal (red solid curves) in different detection schemes. The absorption signal is the difference between the reference measurement (without sample) and the absorbed measurement (with sample), and the noise level is an incoherent addition (quadratic mean) of the total noise level (including DN, SN, and RIN) in these two measurements. Note that we zoom into the central five transitions to show the details more clearly.

FIG. 4. BFS and OPA-BFS for NH₃ ((a)-(b)) and CO₂ ((c)-(d)) around 143.4 THz. The purple dotted lines in (b) and (d) denote the noise level in corresponding BFS spectra (blue dotted curves in (a) and (c)). Note that there are some weak transitions missing around the center of the NH₃ absorption (141-142 THz) due to data missing from HITRAN database.

FIG. 5. Noise and LOD scaling with excitation power of different spectroscopy schemes. (a) Detector noise (DN, blue dashed line), relative intensity noise (RIN, yellow dashed line) and total noise (red dotted curve) in DAS (left y-axis). Green curve (right y-axis) denotes the limit of detection (minimum detectable absorbance, SNR=1) of DAS. (b) LOD scaling with excitation power of different schemes. Solid curves: DAS (green, same as the green solid curve in (a)), BFS (blue), BFS+GA (purple), and OPA-BFS (red). Dashed curves: ideal BFS (iBFS, blue) and iBFS+GA (purple).

FIG. 6a-6d. Tables with various OPO parameters FIG. 7. Mock sample. Spectra of reference measurements (without sample) and absorbed measurements (with sample) for different spectroscopy schemes: (a)(e) DAS, (b)(f) BFS, (c)(g) BFS+GA and (d)(h) BFS+OPA. schemes: (a)(e) DAS, (b)(f) BFS, (c)(g) BFS+GA and (d)(h) BFS+OPA.

FIG. 8. NH₃. Spectra of reference measurements (without sample) and absorbed measurements (with sample) for different spectroscopy. Schemes: (a)(e) DAS, (b)(f) BFS, (c)(g) BFS+GA and (d)(h) BFS+OPA.

FIG. 9. CO₂. Spectra of reference measurements (without sample) and absorbed measurements (with sample) for different spectroscopy schemes: (a)(e) DAS, (b)(f) BFS, (c)(g) BFS+GA and (d)(h) BFS+OPA.

FIG. 10. Mock sample. (a) Time-domain overview from −1 ps to 60 ps. There is about a 50-dB gain for the signal field that temporally overlaps with the pump field. (b) Time domain zoomed into [−1, +1] ps, the center of the signal pulse.

FIG. 11. NH₃. (a) Time-domain overview from −1 ps to 30 ps. There is about a 50-dB gain for the signal field that temporally overlaps with the pump field. (b) Time domain zoomed into [−1, +1] ps, the center of the signal pulse.

FIG. 12. CO₂. (a) Time-domain overview from −1 ps to 40 ps. There is about a 50-dB gain for the signal field that temporally overlaps with the pump field. (b) Time domain zoomed into [−1, +1] ps, the center of the signal pulse.

FIG. 13. Hardware environment.

FIG. 14. Software environment.

FIG. 15. Flowchart illustrating a method of making a device.

FIG. 16. Flowchart illustrating a method of using a device.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

The present disclosure describes new form of spectroscopy named optical-parametric-amplification-enhanced spectroscopy and sensing.

The systems described herein can be used to perform spectroscopy or sensing by selectively amplifying the sample response signal, for example by temporally overlapping the pump pulse and the sample response signal.

The spectroscopy and sensing is illustrated in the context of ro-vibrational spectroscopy, but it is also applicable to other kinds of absorption spectroscopy. First, similar to refs. [14-16], the sample is interrogated by short pulses (generally mid-IR) so as to form an output signal comprising a background residual from the input pulses and a response signal 108 (FID) in the time domain.

In one embodiment, the output signal is directly sent to the nonlinear medium that selectively amplifies the sample response signal and sends the amplified signal to a detector or spectrometer for further processing.

In another embodiment the system performs background-free spectroscopy (OPA-BFS)) wherein the background excitation of which is suppressed by an interferometer. Next, the output from the interferometer, which includes sample response and residual background, is amplified by a short-pulse optical parametric amplifier (OPA). The pump pulses (generally near-IR) of the OPA are kept at a chosen delay relative to the signal pulses (output from the interferometer), so they can amplify a strong part of the FID field while being far away from the center of the original excitation pulses to avoid residual background. Theoretical and numerical characterization demonstrate that this method can further improve the SNR and limit of detection (LOD) of the above-mentioned broadband linear BFS by orders of magnitude, without requiring a lower extinction ratio or time-resolved measurements which can be experimentally challenging.

On one hand, while OPA-BFS amplifies the absorption signal of the samples and make it more detectable, there is no limitation on the type of spectrometer used for spectrum acquisition: one can either use a typical frequency-domain spectrometer, like a grating-based OSA, monochromator, or FTIR, or a time-domain spectrometer, such as dual-comb spectroscopy [21], electro-optic sampling [12,22] or cross-comb spectroscopy [13]. In comparison, existing BFS by temporal gating [9, 11-13] is less flexible because it demands time-resolved spectrometry, which can have some advantages over traditional frequency-domain spectrometry but requires more experimental effort. On the other hand, thanks to the temporal gating provided by short-pulse nonlinearity, OPA-BFS is not limited by and has a relaxed requirement on the extinction ratio of the destructive interference compared to existing broadband BFS based on linear interferometry. Although extinction ratios of ˜10⁻⁴ have been demonstrated [14-16], achieving further extinction remains technically challenging due to misalignment, substrate thickness mismatch and environment noise [15], which strictly limits the advantages of linear BFS.

### Example Systems

### First Embodiment

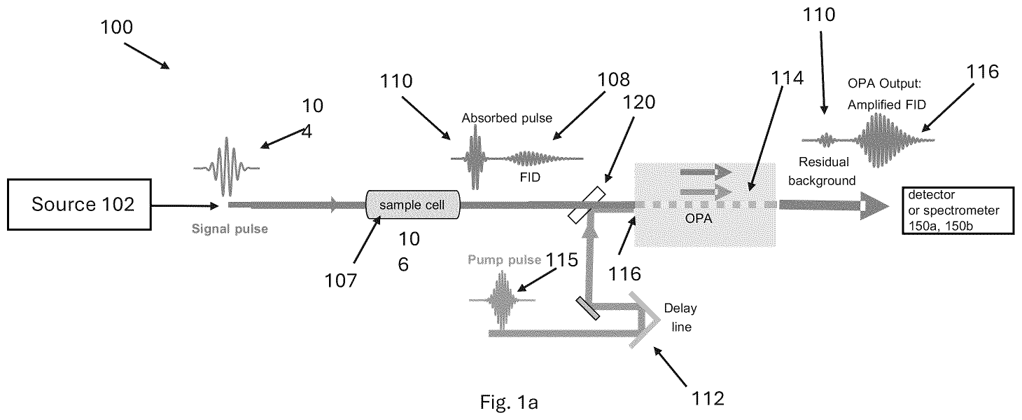

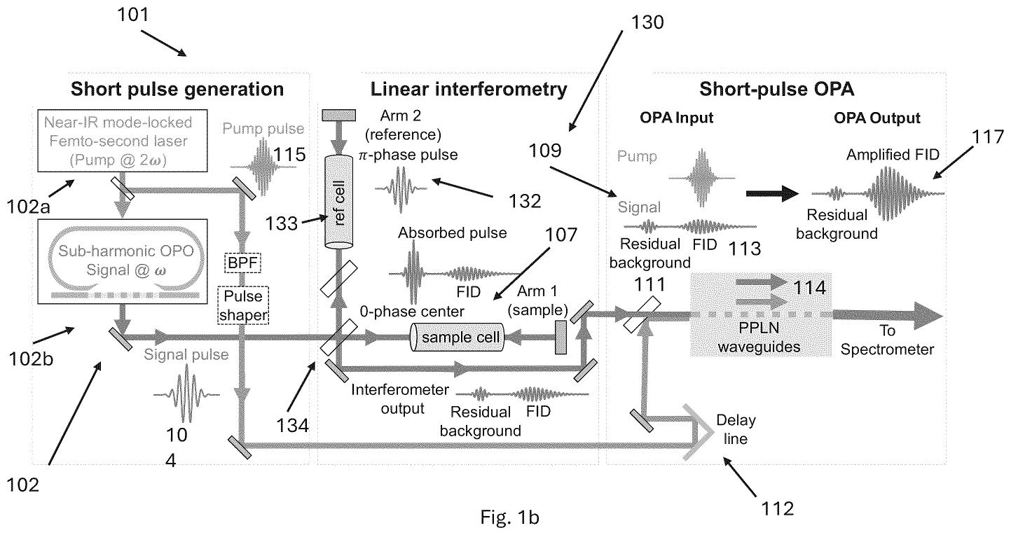

FIG. 1a illustrates a device or system 100 useful as a spectrometer or a sensor, comprising a source 102 of a short electromagnetic pulses 104 at the first wavelength having a full width at half maximum in a range of 1 femtosecond-1 nanosecond: a sample holder 106 (e.g., sample cell) in which the pulses interact with the sample 107 so as to form an output signal comprising a background residual 110 from the input pulses and a response signal 108 (FID) in the time domain. The device or system further comprises a nonlinear medium 114 comprising an input 116 for receiving the output signal and a pump pulse 115 at the second wavelength. The nonlinear medium comprises a second-order nonlinearity configured for a nonlinear process selectively amplifying the sample response signal (e.g., in the time domain), for example by temporally overlapping the pump pulse and the sample response signal:

### Second Embodiment (see also [41])

The architecture of OPA-BFS is presented in FIG. 1b and comprises three parts: short pulse generation, linear interferometry, and short-pulse OPA. While OPA-BFS does not require any specific technique for the pulse generation, FIG. 1b illustrates the source 102 comprises a sub-harmonic optical parametric oscillator (OPO) 102b synchronously pumped by a short-pulse mode-locked laser 102a (typically a fiber laser), which is a common way to generate short mid-IR pulses [25-29]. One important advantage of synchronously-pumped OPOs is that the timing and phase of signal pulses and pump pulses are intrinsically locked, which can exempt additional efforts in their control for the short-pulse OPA [30]. The second step is to use the signal pulses 104 (generally mid-IR) to interrogate the sample with a detection background suppressed by linear interferometry. The output signal 109 of the interferometer consists of two parts, the residual pulse center (background) 111 which cannot be fully eliminated by the interferometer 130 and the subsequent FID signal 113 which carries the spectral information of the sample. Also shown is band pass filter BPF and pulse shaper to create and split off the pump pulse from the same source 102, wherein the pump pulse is used to amplify the signal response 113.

Note that we make a very short and clean separation between the excitation pulse (center) and FID radiation for clarity of the illustration, which is not always the case in practice. However, this will not influence our analysis and arguments, as there will always be part of the FID radiation that is far enough from the excitation pulse center and thus can be separated well

Compared to the residual background (originally the excitation pulse) that is much more localized in the time domain (pulse width of ˜10-100 fs), the FID signal can typically last at least hundreds of ps and sometimes have a local maxima at a relative delay of 10-100 ps [9, 10, 31, 32].

This can be understood equivalently in the frequency domain: while femtosecond pulses can have a bandwidth as broad as tens of THz, a typical vibrational absorption has a linewidth on the order of magnitude of only 10 GHz at room temperature and atmospheric pressure, which can be even smaller at lower pressure or temperature. The output of the interferometer is then sent to a short-pulse OPA (FIG. 1(c)) as the signal to be amplified. The pump pulse is held at a chosen delay with respect to the signal such that it overlaps with a strong portion of the FID but is far away from the excitation center. Therefore, the FID carrying useful sample signatures is amplified while the residual background is not, as it does not temporally overlap with the pump pulse. This can further improve the SNR of the absorption spectrum and make a trace sample detectable that cannot be detected by DAS or linear BFS.

Here, we show the illustration of an OPA based on nanophotonic periodically-poled lithium niobate (PPLN) waveguides [14, 15 in supplementary references], which was recently demonstrated with unprecedented high gain and broad bandwidth. However, it can also be any other platform or material that can support short-pulse OPA with high parametric gain.

### Comparison of Different Spectroscopy Schemes

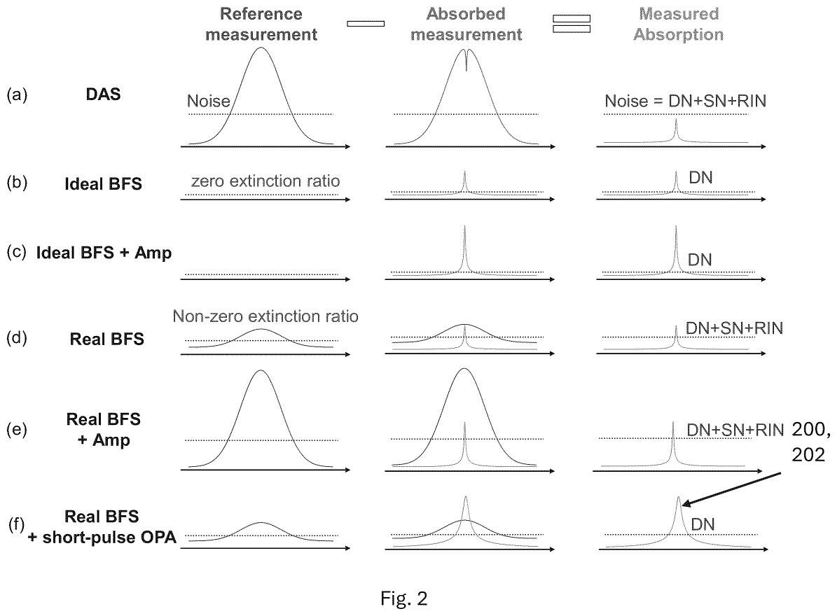

FIG. 2 qualitatively compares different spectroscopy schemes in detecting small absorption (trace sample) to show the advantage of OPA-BFS. In traditional DAS (FIG. 2(a)), one must compare two measurements, one without sample (reference measurement, blue curve) and one with sample (absorbed measurement, red curve), the difference of which is the absorption signal of interest (green curve). There are three primary kinds of noise, detector noise (DN), shot noise (SN) and relative intensity noise (RIN), and any of them may dominate and limit the detection depending on the power incident on the detector. The noise level for each spectrum is denoted by the purple dashed line. Generally, if we assume a high source power which can saturate the detector, the RIN will dominate and fundamentally limit the detection. Therefore, one cannot detect an absorption dip smaller than the RIN, which is proportional to the full power of the light source (excitation background).

In ideal BFS (FIG. 2(b)), the excitation background can be fully eliminated in the reference measurement, and the absorption is converted from (e.g., dark) dip to a (e.g., bright) peak in the absorbed measurement. In this case of perfect background elimination, the power arriving at the detector is from the absorption, the signal of interest, so a noise proportional to (smaller than) the signal does not limit the detection of the existence of the absorption. Therefore, we do not consider RIN as the limiting factor in this ideal case. In principle, SN may still limit the detection. However, here we focus on the case that SN is negligible compared to the DN, which is typically the case for less-advanced detectors (lower detectivity and responsivity), especially in MIR wavelength range [11,14]. This is why we only indicate DN as the main limiting factor here (same for FIGS. 2(c) and (f))—the-absorption peak needs to overcome just the DN to be detectable, which is the only noise that may limit the detection. Note that this does not mean RIN do not exist in the measurement:

they are always present and proportional to the power (RIN) incident on the detector. However, in this case, all power arriving at the detector is from the absorption, the signal of interest, so a noise which is proportional to the signal such as RIN cannot limit the detection. As absorption is a peak instead of a dip in BFS, it is natural to add an amplifier after it, which can further improve the detectability of the signal (FIG. 2(c)). Note that the amplifier here refers to a general ideal frequency-domain amplifier (GA) which does not bring in extra noise and has no temporal features. In these two ideal cases, the LOD (defined as minimum detectable absorbance) is free from detector saturation and RIN or SN and purely decided by the available source power and amplification (if applicable).

However, these two ideal cases are not realistic because the extinction ratio in real linear interferometry is always non-zero and results in a residual background. Although linear BFS can increase the SNR to some extent (FIG. 2(d)), the residual background can still fundamentally limit the LOD via SN or RIN at high power like DAS and prevents detection of lower absorption. Moreover, adding a general (frequency-domain) amplifier after the linear interferometry is not helpful in the RIN-limited regime because the noise (SN and RIN) from the residual background is also amplified by the same factor as the absorption signal (FIG. 2(e)). In contrast, a short-pulse OPA can make a difference (FIG. 2(f)). Upon a proper timing of the pump pulse, one can amplify only the FID (absorption signal) but avoid the excitation pulse center (residual background), which will remain almost the same. Thus, OPA-BFS can further increase the SNR in addition to the enhancement from linear BFS, and the LOD of OPA-BFS is fundamentally limited by the available source power and OPA amplification.

### Example Theoretical Analysis and Numerical Simulation

To further demonstrate the advantages of OPA-BFS quantitatively, theoretical analysis and numerical simulation were performed for different detection schemes and types of samples. The mathematical models for BFS of linear interferometry and noise analysis are based on ref [14-16,33]. Specifically, some important parameters are adapted from a recent state-of-the-art experimental result reported in ref [16], including the field unbalanced factor δ=10⁻² and RIN ratio σᵣ=10⁻². Note that those numbers are very close to the experimental results in ref but with a simpler value for ease of presentation. More importantly, for linear BFS, the model using those two parameters gives a theoretical LOD of absorbance equal to δσᵣ=10⁻⁴, which agrees with what is experimentally demonstrated in ref [16]. The simulation of OPA is based on solution of the coupled wave equations using the Fourier split step method [25,34], the parameters of which are based on experimental demonstrations of high-gain OPA in thin-film lithium niobate [23]. The absorption of molecules is modeled based on data from the HITRAN database [35], using a Lorentz oscillator model for the line profile. Detailed description and parameters of the theoretical and numerical models can be found in the Supplementary Information.

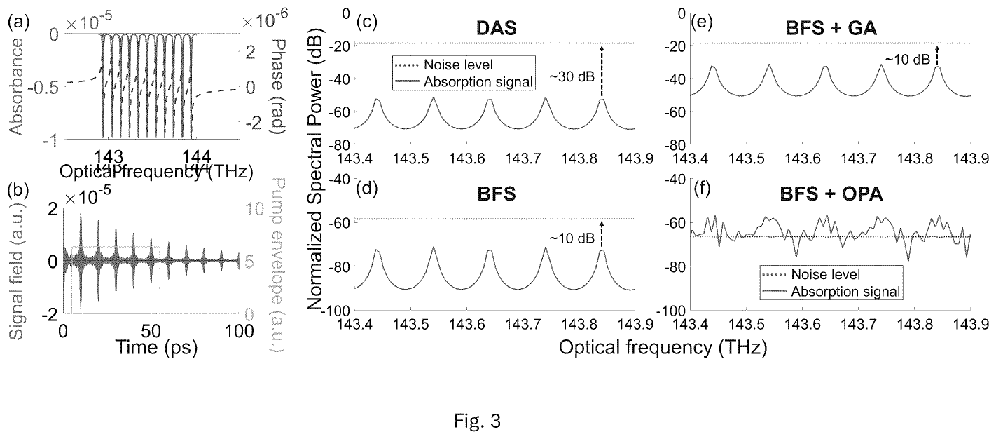

First, a simulation for a mock sample is conducted to give a simple and clear illustration. The mock sample is set to have 11 equally strong and equally spaced Lorentzian transitions with the same linewidth of 6 GHZ. Those transitions are distributed from 143 THz to 144 THz, with a peak absorbance of 10⁻⁵ as shown in FIG. 3(a), together with the phase profile. A sech signal (excitation) pulse with a center wavelength of 2.09 μm (143.4 THz) and a 40-fs pulse width is used to interact with the sample in the interferometer. The output of the interferometer consists of two parts, the residual background (excitation pulse) and FID, part of which is shown in FIG. 3(b) (red curve, left y-axis). One can observe a pattern in the FID with a period of 10 ps, which is a result of the coherent addition of reradiation of those transitions with a 100-GHz spacing [9,31,32]. To amplify the FID, we use a rectangular pump pulse with a center wavelength of 1.045 μm (286.9 THz) and pulse width of 50 ps, the envelope of which is denoted by the yellow curve (right y-axis) in FIG. 3(b). Note that we keep the center of the rectangular pump pulse at a delay of 30 ps with respect to the center of the signal pulse (zero of the time axis), by which the pump can cover a strong part of the FID while avoiding the residual background.

While a more detailed description about the simulation can be found in the Supplementary Information, the results of the absorption signal and noise level in different detection schemes are presented in FIGS. 3(c)-(f). Note that we assume a grating-based spectrometer for detection of the 2.09-μm signal spectra with a resolution of 0.1 nm. Also, we assume a high enough average power for the 2.09-μm excitation pulse such that the peak of its spectrum can just saturate the detector of the spectrometer, and all the spectral power is normalized to it and presented on a logarithmic scale. Therefore, the noise level is about-20 dB in DAS (FIG. 3(c)), which is dominated by RIN, corresponding to a σᵣ=10⁻². As we set an absorbance of 10⁻⁵, the absorption signal level is −50 dB, which is 30-dB weaker than the noise level and thus undetectable in DAS. In linear BFS, while the absorption signal will be lowered by δ, the background will be suppressed by δ² as will the RIN (See Supplementary Information for detailed theoretical derivation). Therefore, the SNR can be increased by 1/δ if the RIN still dominates, which is the case for our example here. As shown in FIG. 3(d)), compared to DAS, the noise level in BFS is suppressed by 40 dB (δ²=10⁻⁴) and now around −60 dB, and the signal level is lowered by 20 dB (δ=10⁻²) and now −70 dB. Obviously, although the SNR has been increased by 20 dB (1/δ), the signal is still below the noise level and thus still undetectable. This agrees with the fact that the absorbance we set here (10⁻⁵) is lower than the LOD of the linear BFS (δσᵣ=10⁻⁴).

Next, the output of the interferometer is amplified with an ideal general amplifier (GA) with a power gain of 40 dB, and the result is shown in FIG. 3(e). Compared to BFS, while the signal is amplified by 40 dB, the noise level is also amplified by the same factor; therefore, the SNR is not increased. We assume a power gain of 40 dB because it corresponds to (1/δ)², which will bring the output spectra back to the saturation level of the spectrometer. One can apply a higher power gain if the spectrometer saturation is not considered, but it still cannot increase the SNR.

Finally, FIG. 3(f) presents the result of OPA-BFS. The absorption signal reaches above −60 dB, which is amplified by about 10 dB in the frequency domain. This frequency-domain amplification factor is much less than that of the GA in panel (e) because the OPA pump pulse only covers a small temporal range of the whole FID. However, as the pump pulse avoids the residual background in the time domain, the noise is not amplified like GA, by which the SNR is effectively increased compared to linear BFS. In fact, a decrease in the noise is observed, because part of the energy of the residual background pulse (2.09 μm) flows to the pump wavelength (1.045 μm) via second harmonic generation (SHG). The SHG here is prominent since the signal pulse is set with a relatively high power because we want to work in the RIN-limited regime. Even if we ignore the SHG effect, the absorption signal reaches above −60 dB, the same as the noise in the linear BFS (see FIG. 3(d)), and so will still be detectable (SNR>=1). In this case, the LOD will be limited by the amplification of the OPA instead of the RIN or detector saturation. There is some observed broadening and distortion of the resolved peaks, which is mainly due to the finite temporal window of the pump pulse and the phase-sensitive nature of the OPA gain. Nevertheless, the basic spectral information, including the center frequencies and relative intensities of the transitions, are well preserved. One can always try to apply a longer pump pulse to cover a wider temporal range to alleviate this problem. However, for a given average power of the pump, there is a trade-off between the peak power (temporal gain) and width (temporal window) of the pump pulse.

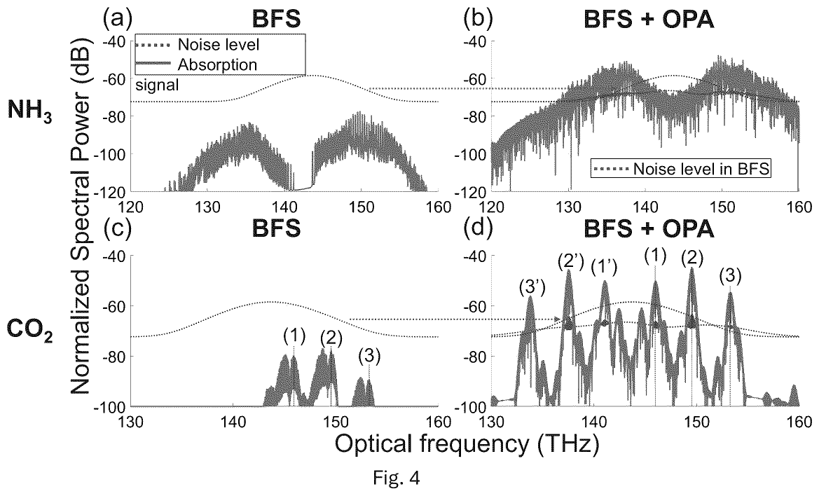

For further demonstration of OPA-BFS, simulation with real molecules was performed. As we have shown that the SNR of BFS can be higher than that of DAS and cannot be further increased by an ideal GA, here we only present the results of BFS and OPA-BFS. Note that the parameters for the linear BFS and noise are the same as those of the last example. Results for NH₃ are shown in FIGS. 4(a)-(b). We set the transition at 151.3 THz, the strongest one around the center frequency of our excitation pulse (143.4 THz), to have an absorbance of 10⁻⁵, so the absorbance of other nearby transitions is smaller than 10⁻⁵. Therefore, all transitions are below the LOD of the linear BFS (see FIG. 4(a)).

Here, we continue to use a rectangular pump pulse but with a shorter pulse width of 20 ps, the center of which is held at a delay of 12 ps. As shown in FIG. 4(b), the absorption signal is above the noise level and well detectable in OPA-BFS. As before, the noise level in OPA-BFS (blue dashed curve) is decreased because of SHG. However, the absorption signal here is also higher than the original noise level in BFS (purple dashed line) and thus still detectable even if we do not consider the SHG effect. The same is observed in the case of CO₂ (see FIG. 4(c)-(d)). For CO₂, there are three groups of transitions of close to 143.4 THz, which are around 145.8 THz, 149.6 THz, and 153.3 THz, as labeled in FIG. 4(c). The transition at 149.6 THz, the strongest among the three groups, is set to have an absorbance of 10⁻⁵.

Here, different from previous cases, a sech pump pulse with a pulse width of 5 ps at a relative delay of 25 ps is used to amplify the FID. FIG. 4(d) shows that OPA-BFS makes the absorption signal stronger than the noise and thus readily detectable. Although there are some distortions to the absorption profile as we use a relatively short pump pulse for higher gain, the center of each transition group is well captured (see the labels corresponding to panel (c)), which can be enough for detection and identification of the molecule. Notably, new frequency components (labeled (1′), (2′), and (3′)) are found on the other half of the spectrum. They are idler radiation generated in the OPA and thus symmetric to their corresponding signal frequencies with respect to the center frequency (143.4 THz). If we also include the radiation around the idler frequencies into our detection, the SNR and LOD can be further enhanced. In summary, it has been demonstrate that OPA can enhance the LOD of linear BFS for both molecules by more than one order of magnitude, considering that the absorbance for both molecules is less than or equal to 10⁻⁵.

Note that the obtained absorption signal in OPA-BFS depends on many parameters, including the power, profile, width, and center delay of the pump pulse, and we only show one possibility for each example above. Moreover, there is a trade-off between temporal gain and spectral resolution, the essence of which is the trade-off between width and peak power of pump pulse with a fixed average power. A complete and systematic optimization of those parameters can be performed.

Noise and LOD Scaling with Excitation Power

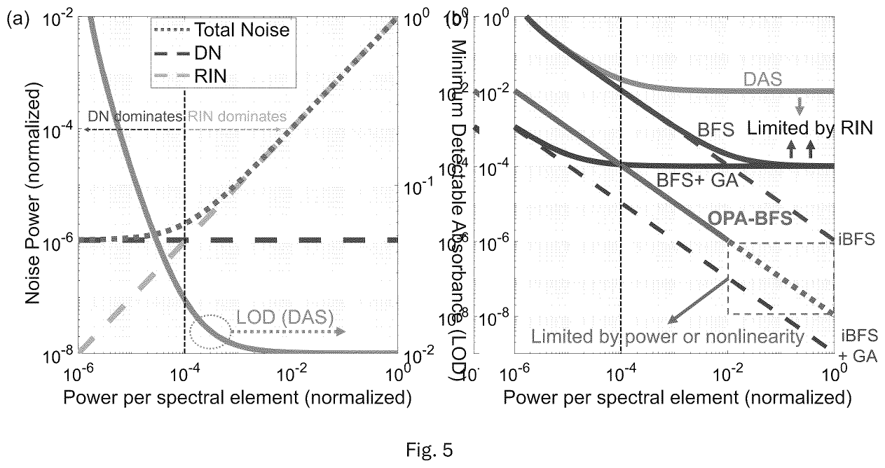

FIG. 5 illustrates how the noise and LOD scale with excitation power for different detection schemes. For these results, a detector saturation power of 0.1 mW is assumed and all power displayed is normalized to it. More details and parameters for this calculation can be found in the Supplementary Information. FIG. 5(a) first depicts the scaling of the noise (left y-axis) for DAS as an example. In DAS, the total noise is dominated by detector noise (DN) or RIN when the relative excitation power is smaller or larger than 10⁻⁴, respectively. This power scaling is basically similar to FIG. 1 of ref. [33] despite two differences. One is that we do not consider dynamic range of the whole detection system. The other is that the shot noise in our case is negligible and thus not shown in the figure, which is consistent with the finding in ref [16].

If defining “detectable” as SNR=1, the corresponding LOD for DAS can be calculated and is denoted by the green solid curve (right y-axis). While higher power leads to a lower LOD when the DN dominates, the LOD stops decreasing and converges to 10⁻² (or) as the RIN dominates. Following DAS, the LOD scaling of other schemes is depicted in FIG. 5(b). The LOD of BFS (blue solid curve) can be lower than that of DAS because of the RIN suppression, but it is still ultimately limited by RIN and converges to a fixed lower bound of 10⁻⁴ (σ^{r}, δ). An ideal general amplifier can decrease LOD of BFS at low power (purple solid curve), but it stops helping at higher power as the detector becomes saturated and the detection is limited by the RIN in the same way as the case without amplification. Finally, the red solid curve denotes the LOD of OPA-BFS. At low power, OPA is not as helpful as GA due to a gain penalty we set with it, since short-pulse OPA amplifies only a part of the signal in the time domain. However, OPA-BFS outperforms GA-BFS and linear BFS at higher power as its LOD continues to scale down because it is not limited by RIN. When the excitation power per spectral element is higher than a specific limit, which would vary case by case and we set 10⁻² in this figure, further scaling down of the LOD in OPA-BFS (dotted red curve) depends on the availability of the total excitation pulse power or on having enough parametric gain for a high-power signal input. Note that two dashed lines, blue for ideal BFS (iBFS) and purple for iBFS+GA, are also displayed as useful references although they are not practical. In summary, although BFS can lower the LOD of DAS to some extent, it is still limited by RIN at high powers due to a non-zero extinction ratio. While a general amplifier cannot effectively help, a short-pulse OPA can further lower the LOD of BFS by order(s) of magnitude.

### Supplementary Information on Simulations and Theory

### 1. Theoretical Model of BFS Based on Linear Interferometry

To further demonstrate OPA-BFS quantitatively, we conduct theoretical analysis and numerical simulation for different schemes. The mathematical models for BFS of linear interferometry and noise analysis are based on ref [14-16,33]. Specifically, some important parameters are adapted from a recent state-of-the-art experimental result reported in ref [3], including the field unbalanced factor δ=10⁻² and RIN ratio or =10⁻². These numbers are very close to the experimental results in but with a simpler value for ease of presentation. More importantly, for linear BFS, the model using those two parameters gives a theoretical LOD of absorbance equal to δσ^{r}=10⁻⁴, which agrees with what is experimentally demonstrated in ref [16].

The amplitudes of electric field in the sample arm (“Arm 1”, subscript “spa”) and reference arm (“Arm 2”, subscript “rfa”) are described as:

$${E}_{s p a} = {E}_{0} {e}^{- \frac{A}{2}} \qquad ( 1 )$$

$${E}_{r f a} = - {E}_{0} ( 1 + δ ) \qquad ( 2 )$$

In the equation of Eₛₚₐ, A denotes a small absorbance (A<<1). In the equation of E_{rfa}, the negative sign denotes a n phase change (destructive interference), and δ is the field unbalanced factor, which is assumed real in this work. Note that we assume a small absorbance A<<δ. Also, we assume a power P₀=cE₀², where c is a proportional constant and will be omitted in the following derivation. Therefore, the total optical power entering the interferometer is approximately 2P₀. At the output of the interferometer, the amplitude and power of the combined field are:

$$E = {E}_{s p a} + {E}_{r f a} = - {E}_{0} ( 1 - {e}^{- \frac{A}{2}} + δ ) ≅ - {E}_{0} ( \frac{A}{2} + δ ) \qquad ( 3 )$$

$$P = {E}^{2} = {{E}_{0}^{2} ( \frac{A}{2} + δ )}^{2} ≅ {P}_{0} ( {δ}^{2} + A δ ) \qquad ( 4 )$$

Therefore, in BFS, the optical power incident on the detector of the reference (without sample, A=0) and absorbed measurements is:

$${P}_{r e f}^{B F S} = {P}_{0} ( {δ}^{2} ) \qquad ( 5 )$$

$${P}_{a b s}^{B F S} = {P}_{0} ( {δ}^{2} + A δ ) \qquad ( 6 )$$

The absorption signal, i.e., the difference between these two measurements, is

$${P}_{S}^{B F S} = {P}_{0} ( A δ ) \qquad ( 7 )$$

Similarly, for direct absorption spectroscopy (DAS), we have:

$${P}_{r e f}^{D A S} = {P}_{0} \qquad ( 8 )$$

$${P}_{a b s}^{D A S} = {P}_{0} {e}^{- A} ≅ {P}_{0} ( 1 - A ) \qquad ( 9 )$$

$${P}_{s}^{B F S} = {P}_{0} A \qquad ( 10 )$$

As for the noise,

$${P}_{N} = \sqrt{{P}_{D N}^{2} + {P}_{S N}^{2} + {P}_{RIN}^{2}} = \sqrt{{P}_{D N}^{2} + {P}_{t} h {v ( Δ f )}^{- 1} + {( {P}_{t} {σ}_{r} )}^{2}} \qquad ( 11 )$$

Here, P_{DN}, P_{SN}, and P_{RIN} denote the detector noise (DN), shot noise (SN), and relative intensity noise (RIN), respectively. Pₜ denotes the average total power incident on the detector, and σᵣ denotes the RIN. h is Planck's constant, v is the optical frequency, and Δf is the measurement bandwidth (reciprocal of the measurement time for each spectral element).

In the examples presented herein, shot noise is negligible compared to the other two kinds of noise under our assumptions. On one hand, this is generally the case for less advanced detectors, especially in the MIR region. On the other hand, this agrees with the result of some previous experimental works, for example, ref. [16]. Next, we define a “detectable signal” as having a SNR=1 (Pₛ=Pₙ). Hence, for BFS at high powers, when RIN dominates, we have:

$${P}_{S} = {P}_{0} ( {A}_{L O D}^{B F S} δ ) = {P}_{N} = {P}_{0} ( {δ}^{2} ) {σ}_{r} \qquad ( 12 )$$

$${A}_{L O D}^{B F S} = δ {σ}_{r} \qquad ( 13 )$$

For DAS, we have

$${P}_{S} = {P}_{0} {A}_{L O D}^{D A S} = {P}_{N} = {P}_{0} {σ}_{r} \qquad ( 14 )$$

$${A}_{L O D}^{D A S} = {σ}_{r} \qquad ( 15 )$$

The above derivation shows that, in the RIN-limited regime, P_{S}^{BFS}=δP_{S}^{DAS} and P_{N}^{BFS}=δ²P_{N}^{DAS}, giving the conclusion A_{LOD}^{BFS}=δA_{LOD}^{DAS}. In other words, in linear BFS, while the absorption signal will be lowered by δ, the background will be suppressed by δ² as will the RIN. Therefore, the SNR can be increased by 1/δ. This shows the SNR advantage of BFS in the RIN-limited regime, as & is generally very small (δ<<1), and also highlights the benefits of reducing the field unbalanced factor or at least suppressing its effect.

### 2. Simulation Model and Parameters

The simulation of OPA is based on solution of the coupled wave equations using the Fourier split step method [25,34], the parameters of which are based on a recent experimental demonstration of a high-gain OPA by thin-film lithium niobate nanophotonics [23]. The absorption of molecules is modeled based on data from the HITRAN database [35], using a Lorentz oscillator model for the line profile.

### 2.1 Simulation Model

Simulation of the optical parametric amplification (OPA) process between the pump at frequency 20 and signal at frequency ω in the nonlinear crystal is based on solving the coupled wave equations as in ref. [25], which are given as:

$${\partial }_{Z} {E}_{ω} ( z , t ) = κ {E}_{2 ω} {E}_{ω}^{*} - \frac{{α}_{ω}}{2} + {\hat{D}}_{ω} {E}_{ω} \qquad ( 16 )$$

$${\partial }_{z} {E}_{2 ω} ( z , t ) = - κ {E}_{ω}^{2} - \frac{{α}_{2 ω}}{2} - {Δβ}^{′} {\partial }_{t} {E}_{2 ω} + {\hat{D}}_{2 ω} {E}_{2 ω} \qquad ( 17 )$$

where we have taken the time coordinate, t, to be co-moving with the signal. Additionally, the pump envelope phase has been shifted by π/2 to ensure real solutions if higher orders of dispersion are not considered. In these equations, the subscripts ω and 2ω are used to denote the signal and pump, respectively. Eᵢ, i∈{ω, 2ω}, denotes the electric field amplitude, normalized such that |Eᵢ|² gives the instantaneous power. The nonlinear coupling coefficient is given by K=\sqrt{2η₀}ωd_{eff}/(wn_{ω}\sqrt{πn_{2ω}}c), where no is the impedance of free space, d_{eff} is the effective nonlinearity, w is the beam radius where a symmetric Gaussian mode has been assumed, nᵢ is the refractive index, and c is the speed of light. αᵢ is the absorption coefficient, which accounts for losses incurred during propagation in the waveguide. The group velocity mismatch between pump and signal is given by Δβ′. Finally,

$${\hat{D}}_{i} = {\sum }_{m = 2}^{∞} [ \frac{{( - i )}^{m + 1} {β}_{m}^{( m )}}{m 13} ]$$

is the dispersion operator, which describes the material dispersion experienced by the pump and signal during propagation in the waveguide. In our simulation, we consider up to third order dispersion.

For simulating the signal response to propagation through the sample, we use a Lorentz oscillator model to compute the complex refractive index of the gas of interest. Specifically, we find the index, n(ω) as:

$${n}^{2} ( ω ) = 1 + {\sum }_{i j} \frac{{f}_{i j} {N}_{j} {q}^{2}}{2 {ε}_{0} {m}_{e} ( {ω}_{i j}^{2} - {ω}^{2} + i {γ}_{i j} ω )} \qquad ( 18 )$$

Here, the indices i,j refer to the upper and lower state of the transition, fᵢⱼ is the oscillator strength, Nⱼ is the number density of molecules in state j, q is the electron charge, ε₀ is the vacuum permittivity, mₑ is the mass of the electron, ωᵢⱼ is the center frequency of the transition, and γᵢⱼ is the linewidth. n(ω) may be separated into its real and imaginary components,

$$n ( ω ) = {n}^{′} ( ω ) - i κ ( ω ) \qquad ( 19 )$$

where the imaginary part, K(ω) defines the absorption experienced because of the interaction of light with the sample, and n′(ω) accounts for the signal dispersion. The Lorentz oscillator defined as such allows us the flexibility to simulate multiple gases, as presented in the results of the main text, using parameters provided by the HITRAN database [35]. Additionally, we may use this model to define mock samples with arbitrary linewidths, strengths, and center frequencies to investigate theoretically more easily the consequence of these various parameters on the system response.

### 2.2 Waveguide Parameters

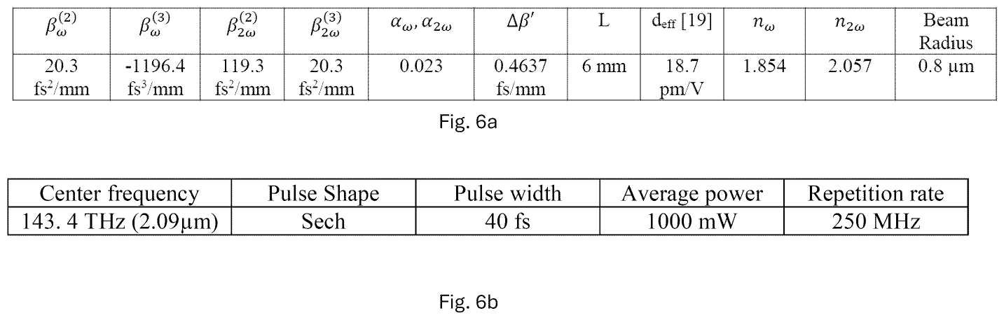

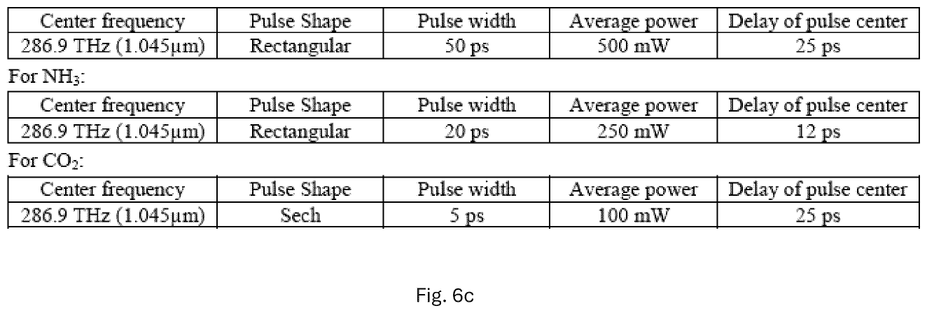

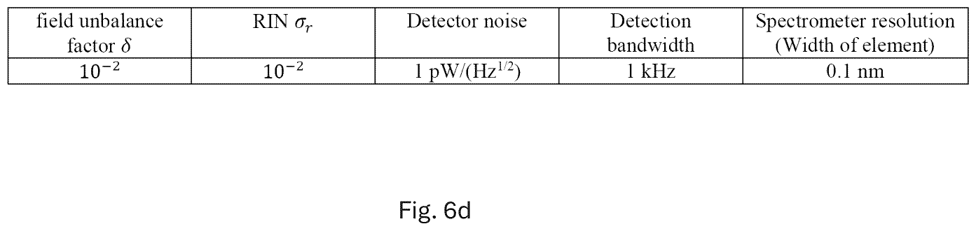

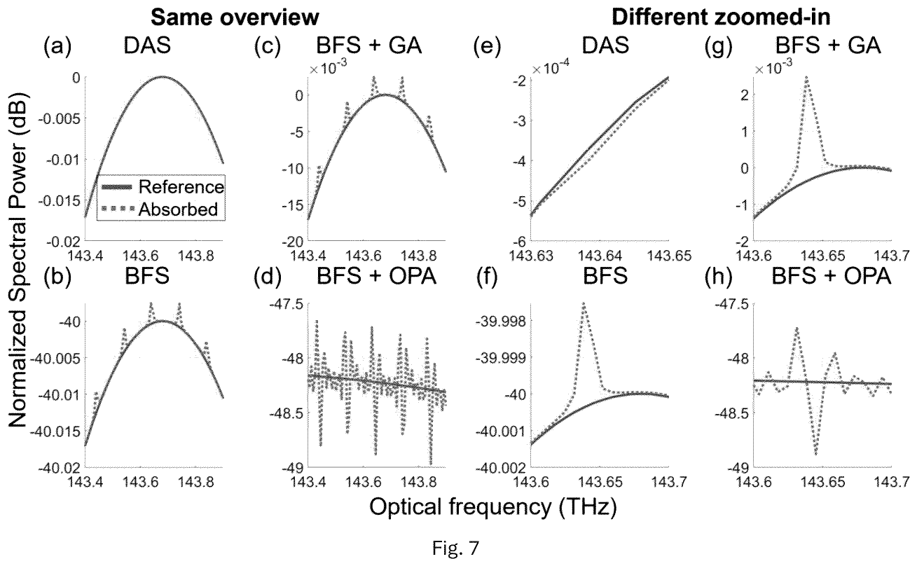

The parameters used for simulating the nonlinearity are based on OPA in a thin-film lithium niobate waveguide, as in ref. [23]. We consider a 700-nm thin film deposited on a silica substrate. The waveguide is taken to have a width of 1800 nm, and an etch depth of 375 nm. This gives rise to the following simulation parameters in Table 1 in FIG. 6a:

### 2.3 Signal (Mid-IR) Pulse

The average power of 1000 mW leads to a power per spectral element ˜0.1-1 mW/0.1 nm around the center wavelength of the signal spectrum, which can just reach the assumed detector saturation (1 mW) (for DAS) and make the detection RIN-limited (for DAS, BFS, and BFS+GA). Note that we use the same signal parameters for all simulations.

### 2.4 Pump Pulse

We use different pump pulses for different samples. Note that the repetition rate of all pump pulses is the same as that of the signal pulse, 250 MHz. See FIG. 6c for parameters used for various gases.

Note that there is always a trade-off between temporal gain and spectral resolution, the essence of which is the trade-off between width and peak power of pump pulse with a fixed average power.

### 2.5 Noise and Field Unbalance Factor

The parameters in FIG. 6d are either adapted from the experimental values of ref [14-16] or from typical values of commercial devices.

### 2.6 Spectrometer

We assume a grating-based spectrometer for detection of the 2.09-μm signal spectra with a resolution of 0.1 nm.

### 3. Supplementary Details and Results of Simulation

For FIG. 3 of the main text (the simulation of mock sample), we assume a high enough average power (1000 mW) for the 2.09 μm excitation pulse such that the peak of its spectrum can just saturate the detector of the spectrometer, and all the spectral power is normalized to it and presented on a logarithmic scale (panel (c)-(f)). In FIG. 3(b), we plot the FID field of the interferometer output (red curve, y-axis) when the sample is present (absorbed measurement). In fact, there we also plot the field of the interferometer output when sample is absent (reference measurement), denoted by the blue curve. It includes only the residual background from the excitation pulse: no FID as there is no sample. However, as we zoom in here to show the details of the red curve, the blue curve visually overlaps with the left y-axis and the x-axis. This is because it is strong only within a very small time delay (40-fs excitation pulse) and becomes very weak, effectively zero compared to the red curve, at large time delay as it does not have FID. In FIG. 3(c)-(f), the absorption signal is the difference between the reference measurement (without sample) and the absorbed measurement (with sample), and the noise level is an incoherent addition (quadratic mean) of the total noise level (including DN, SN, and RIN) in these two measurements. In FIG. 3(e) (general amplifier in the simulation of mock sample), we assume a power gain of 40 dB because it corresponds to (1/δ)², which will bring the output spectra back to the saturation level of the spectrometer. We can observe a prominent SHG effect here, as well as in the simulation of NH₃, and CO₂, because the signal pulse is set with a relatively high power as we want to work in the RIN-limited regime. Moreover, for this mock sample, one can always try to apply a longer pump pulse to cover a wider temporal range to alleviate the broadening and distortion of the resolved peaks. However, for a given pump average power, there is a trade-off between the temporal gain (peak power) and the temporal window (pulse width).

In the simulation of NH₃ (FIG. 4(a)-(b) of the main text), there are some weak transitions missing around the center of the absorption (141-142 THz) due to data missing from HITRAN database. The parameters of the linear BFS and noise remain the same as before.

In FIG. 5(a), the power scaling is basically similar to FIG. 1 of Ref despite two differences. One is that we do not consider the dynamic range of the detection system. The other is that the shot noise in our case is negligible compared to DN and RIN and thus is not shown in the figure, which is consistent with the finding in Ref [16].

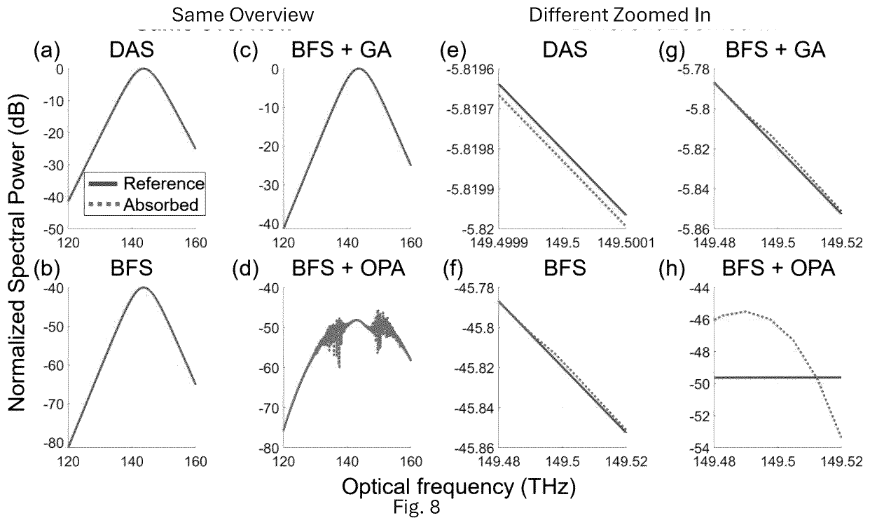

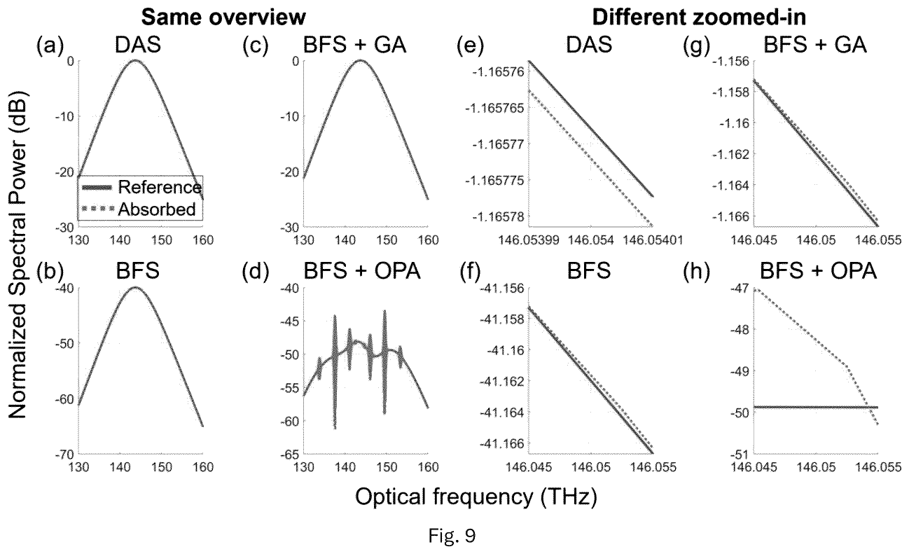

FIGS. 7-9 present more results of simulation for mock sample, NH₃, and CO₂, respectively. Panels (a)-(d) depict the spectra of reference measurements (without sample) and absorbed measurements (with sample) for different spectroscopy schemes in the same optical frequency range as the corresponding figures of the main text, in which the absorption signal is the difference between these two measurements. Note that the two curves in the panels (a) of Supplementary FIGS. 24, as well as panels (b)-(c) of Supplementary FIGS. 3-4, are not visibly distinguishable because the absorption is tiny compared to the background. Therefore, we further zoomed in differently for different detection schemes to show the spectral difference, depicted in panels (e)-(h). Note that while panels (f)-(h) (BFS, BFS+GA, BFS+OPA) use the same zoom, panels (e) (DAS) are particularly more zoomed in to show the smaller difference.

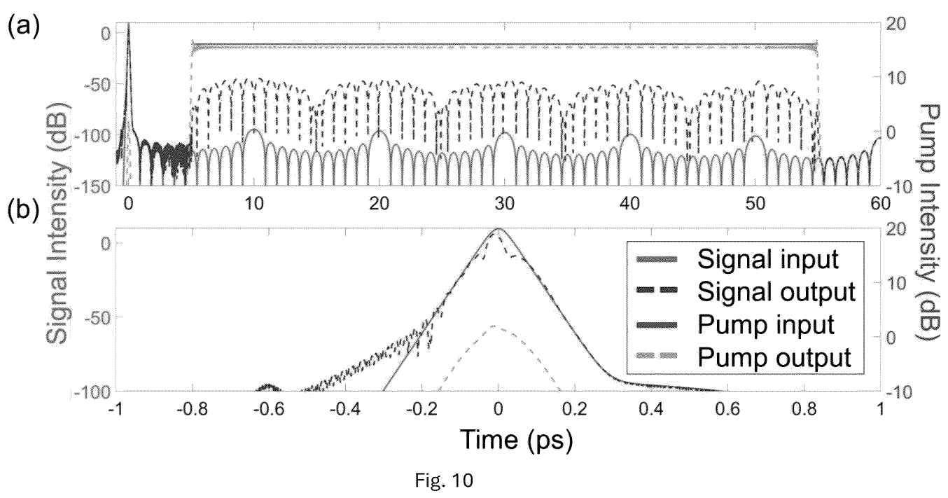

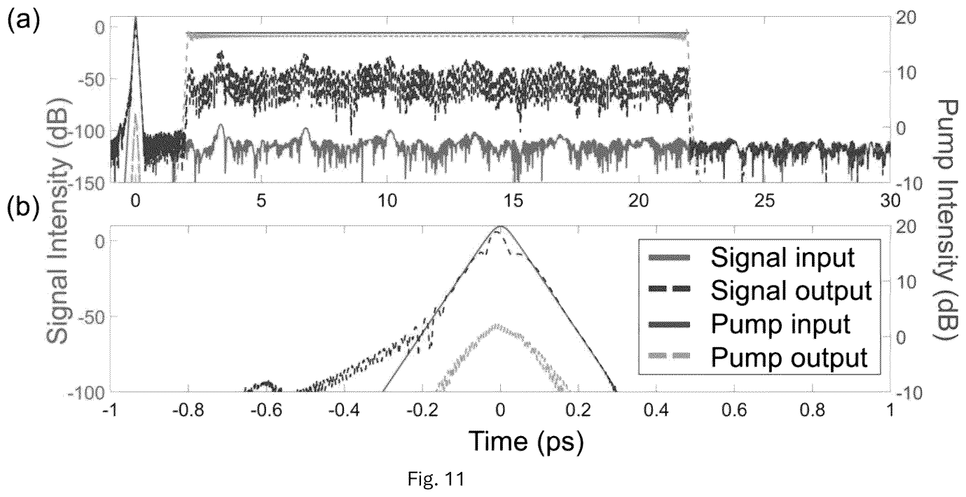

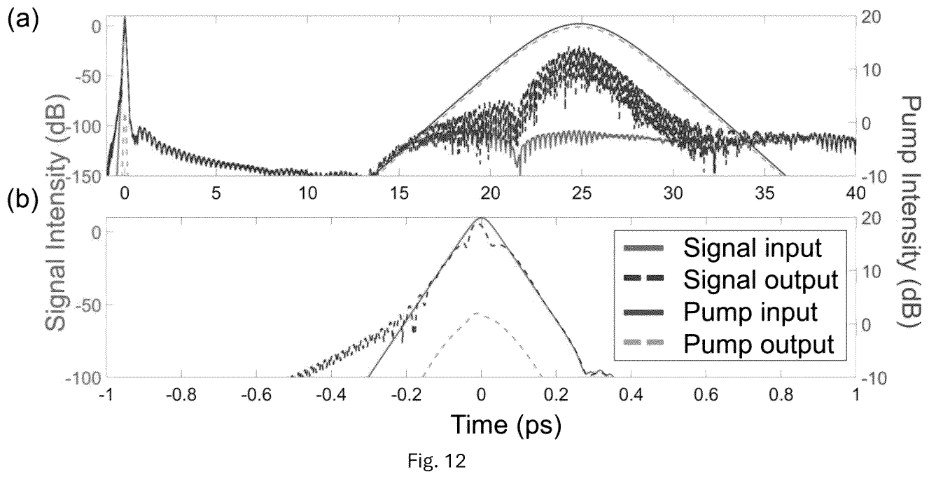

FIGS. 10-12 show the time domain signal of the absorbed measurement in OPA-BFS. Panel (a) of each figure is a time-domain overview and mostly presents the FID part of the signal field that overlaps with the pump field, where the signal field is amplified by the pump field, i.e., energy flows from pump to signal. In contrast, panel (b) zooms into the center of the signal pulse (excitation background), where one can observe decrease in the signal field and generation of new pump field because energy flows from the signal field to the pump field as a result of SHG.

### Advantages and Improvements

The above discussion shows how short-pulse OPA-BFS can be practically useful compared to GA-BFS due to its ability to selectively amplify a portion of the time-domain signal, resulting in temporal gating. This motivates consideration of the method in comparison to other nonlinear sensing techniques, which may also provide temporal gating or up-conversion capabilities. One distinct advantage of OPA is its unique ability to achieve exponential amplification in the signal due to the conversion of photons from the pump [36,37], with amplification factors on the order of 100 dB/cm having been readily achieved [23]. This makes its gain and efficiency much higher than techniques based on, for example, second-harmonic generation or sum-frequency generation for the measurement of ultraweak signals [12,13,22], for which the output photon number cannot exceed the input signal photon number, placing a fundamental limit on the potential amplification [38]. OPA-BFS may also be considered in the non-degenerate regime, where signal up- or down-conversion is possible in addition to amplification and background can be intrinsically zero even without linear interferometry.

In summary, a new method named OPA-BFS is disclosed in which the FID signal is selectively amplified in the time domain. While it can achieve a higher SNR and lower LOD in broadband vibrational spectroscopy by orders of magnitude, it does not require a lower extinction ratio or time-resolved measurements, which is experimentally challenging but has remained essential to existing BFS works. OPA-BFS not only combines and improves upon many merits of demonstrated techniques for background-free vibration spectroscopy, including both linear and nonlinear ones, but also circumvents some of their practical challenges. This work sheds new light on the potential for detection of trace molecules enhanced by optical nonlinearity, which can enable new limits in broadband vibrational spectroscopy and benefit numerous applications. Recently, there have been substantial advances in high-power and broadband mid-IR femtosecond pulse generation [25,27,28] and unprecedented optical nonlinearity enabled by lithium niobate nanophotonics [23,24,39], which can enable experimental realization of this technique on both free-space and on-chip platforms.

### REFERENCES

The following references are incorporated by reference herein
1. Q. Liang, Y.-C. Chan, P. B. Changala, D. J. Nesbitt, J. Ye, and J. Toscano, “Ultrasensitive multispecies spectroscopic breath analysis for real-time health monitoring and diagnostics,” Proceedings of the National Academy of Sciences 118, e2105063118 (2021).
2. M. Jamrógiewicz, “Application of the near-infrared spectroscopy in the pharmaceutical technology,” Journal of Pharmaceutical and Biomedical Analysis 66, 1-10 (2012).
3. B. Nozière, M. Kalberer, M. Claeys, J. Allan, B. D′Anna, S. Decesari, E. Finessi, M. Glasius, I. Grgić, J. F. Hamilton, T. Hoffmann, Y. Iinuma, M. Jaoui, A. Kahnt, C. J. Kampf, I. Kourtchev, W. Maenhaut, N. Marsden, S. Saarikoski, J. Schnelle-Kreis, J. D. Surratt, S. Szidat, R. Szmigielski, and A. Wisthaler, “The Molecular Identification of Organic Compounds in the Atmosphere: State of the Art and Challenges,” Chem. Rev. 115, 3919-3983 (2015).
4. G. A. West, J. J. Barrett, D. R. Siebert, and K. V. Reddy, “Photoacoustic spectroscopy,” Review of Scientific Instruments 54, 797-817 (1983).
5. C. Haisch, “Photoacoustic spectroscopy for analytical measurements,” Meas. Sci. Technol. 23, 012001 (2011).
6. R. Lewicki, J. H. Doty, R. F. Curl, F. K. Tittel, and G. Wysocki, “Ultrasensitive detection of nitric oxide at 5.33 μm by using external cavity quantum cascade laser-based Faraday rotation spectroscopy,” Proceedings of the National Academy of Sciences 106, 12587-12592 (2009).
7. W. Zhao, G. Wysocki, W. Chen, E. Fertein, D. L. Coq, D. Petitprez, and W. Zhang, “Sensitive and selective detection of OH radicals using Faraday rotation spectroscopy at 2.8 μm,” Opt. Express 19, 2493-2501 (2011).
8. J. W. Daily, “Laser induced fluorescence spectroscopy in flames,” Progress in Energy and Combustion Science 23, 133-199 (1997).
9 A. A. Lanin, A. A. Voronin, A. B. Fedotov, and A. M. Zheltikov, “Time-domain spectroscopy in the mid-infrared,” Sci Rep 4, 6670 (2014).
10. A. A. Lanin, A. B. Fedotov, and A. M. Zheltikov, “Ultrabroadband XFROG of few-cycle mid-infrared pulses by four-wave mixing in a gas,” J. Opt. Soc. Am. B 31, 1901 (2014).
11. H. U. Stauffer, S. W. Grib, S. A. Schumaker, and S. Roy, “Broadband, background-free methane absorption in the mid-infrared,” Opt. Express 29, 21011 (2021).
12. I. Pupeza, M. Huber, M. Trubetskov, W. Schweinberger, S. A. Hussain, C. Hofer, K. Fritsch, M. Poetzlberger, L. Vamos, E. Fill, T. Amotchkina, K. V. Kepesidis, A. Apolonski, N. Karpowicz, V. Pervak, O. Pronin, F. Fleischmann, A. Azzeer, M. Žigman, and F. Krausz, “Field-resolved infrared spectroscopy of biological systems,” Nature 577, 52-59 (2020).
13. M. Liu, R. M. Gray, L. Costa, C. R. Markus, A. Roy, and A. Marandi, “Mid-infrared cross-comb spectroscopy,” Nat Commun 14, 1044 (2023).
14. T. Tomberg, A. Muraviev, Q. Ru, and K. L. Vodopyanov, “Background-free broadband absorption spectroscopy based on interferometric suppression with a sign-inverted waveform,” Optica 6, 147-151 (2019).
15. T. Buberl, P. Sulzer, A. Leitenstorfer, F. Krausz, and I. Pupeza, “Broadband interferometric subtraction of optical fields,” Opt. Express 27, 2432-2443 (2019).
16. W. Song, D. Okazaki, I. Morichika, and S. Ashihara, “Broadband background-free vibrational spectroscopy using a mode-locked Cr:ZnS laser,” Opt. Express 30, 38674 (2022).
17. T. T. Fricke, N. D. Smith-Lefebvre, R. Abbott, R. Adhikari, K. L. Dooley, M. Evans, P. Fritschel, V. V. Frolov, K. Kawabe, J. S. Kissel, B. J. J. Slagmolen, and S. J. Waldman, “DC readout experiment in Enhanced LIGO,” Class. Quantum Grav. 29, 065005 (2012).
18. T. F. Zehnpfennig, O. Shepherd, S. Rappaport, W. P. Reidy, and G. Vanasse, “Background suppression in double-beam interferometry,” Appl. Opt. 18, 1996-2002 (1979).
19. Z. Guan, M. Lewander, and S. Svanberg, “Quasi zero-background tunable diode laser absorption spectroscopy employing a balanced Michelson interferometer,” Opt. Express 16, 21714 (2008).
20. J. Hayden, S. Hugger, F. Fuchs, and B. Lendl, “A quantum cascade laser-based Mach-Zehnder interferometer for chemical sensing employing molecular absorption and dispersion,” Appl. Phys. B 124, 29 (2018).
21. I. Coddington, N. Newbury, and W. Swann, “Dual-comb spectroscopy,” Optica 3, 414-426 (2016).
22. A. S. Kowligy, H. Timmers, A. J. Lind, U. Elu, F. C. Cruz, P. G. Schunemann, J. Biegert, and S. A. Diddams, “Infrared electric field sampled frequency comb spectroscopy,” Science Advances 5, eaaw8794 (2019).
23. L. Ledezma, L. Ledezma, R. Sekine, Q. Guo, R. Nehra, S. Jahani, and A. Marandi, “Intense optical parametric amplification in dispersion-engineered nanophotonic lithium niobate waveguides,” Optica 9, 303-308 (2022).
24. M. Jankowski, M. Jankowski, M. Jankowski, N. Jornod, N. Jornod, C. Langrock, B. Desiatov, A. Marandi, M. Lončar, and M. M. Fejer, “Quasi-static optical parametric amplification,” Optica 9, 273-279 (2022).
25. M. Jankowski, A. Marandi, C. R. Phillips, R. Hamerly, K. A. Ingold, R. L. Byer, and M. M. Fejer, “Temporal Simultons in Optical Parametric Oscillators,” Phys. Rev. Lett. 120, 053904 (2018).
26. C. F. O'Donnell, S. C. Kumar, P. G. Schunemann, and M. Ebrahim-Zadeh, “Femtosecond optical parametric oscillator continuously tunable across 3.6-8 μm based on orientation-patterned gallium phosphide,” Opt. Lett. 44, 4570-4573 (2019).
27. M. Liu, R. M. Gray, A. Roy, K. A. Ingold, E. Sorokin, I. Sorokina, P. G. Schunemann, and A. Marandi, “High-Power Mid-IR Few-Cycle Frequency Comb from Quadratic Solitons in an Optical Parametric Oscillator,” Laser & Photonics Reviews 2200453 (2022).
28. Q. Ru, T. Kawamori, P. G. Schunemann, S. Vasilyev, S. B. Mirov, S. B.

Mirov, and K. L. Vodopyanov, “Two-octave-wide (3-12 μm) subharmonic produced in a minimally dispersive optical parametric oscillator cavity,” Opt. Lett. 46, 709-712 (2021).
29. J. Zhang, C. Ning, J. Heng, S. Yu, and Z. Zhang, “Ultra-Short Pulse Generation From Optical Parametric Oscillators With a Cavity-Length Detuning,” IEEE Photonics Technology Letters 34, 263-266 (2022).
30. A. Marandi, N. C. Leindecker, V. Pervak, R. L. Byer, and K. L. Vodopyanov, “Coherence properties of a broadband femtosecond mid-IR optical parametric oscillator operating at degeneracy,” Opt. Express 20, 7255-7262 (2012).
31. H. Harde, S. Keiding, and D. Grischkowsky, “THz commensurate echoes: Periodic rephasing of molecular transitions in free-induction decay,” Phys. Rev. Lett. 66, 1834-1837 (1991).
32. I. Coddington, W. C. Swann, and N. R. Newbury, “Time-domain spectroscopy of molecular free-induction decay in the infrared,” Opt. Lett. 35, 1395-1397 (2010).
33. N. R. Newbury, I. Coddington, and W. Swann, “Sensitivity of coherent dual-comb spectroscopy,” Opt. Express 18, 7929-7945 (2010).
34. R. Hamerly, A. Marandi, M. Jankowski, M. M. Fejer, Y. Yamamoto, and H. Mabuchi, “Reduced models and design principles for half-harmonic generation in synchronously pumped optical parametric oscillators,” Phys. Rev. A 94, 063809 (2016).
35. I. E. Gordon, L. S. Rothman, R. J. Hargreaves, R. Hashemi, E. V. Karlovets, F. M. Skinner, E. K. Conway, C. Hill, R. V. Kochanov, Y. Tan, P. Wcislo, A. A. Finenko, K. Nelson, P. F. Bernath, M. Birk, V. Boudon, A. Campargue, K. V. Chance, A. Coustenis, B. J. Drouin, J.-M. Flaud, R. R. Gamache, J. T. Hodges, D. Jacquemart, E. J. Mlawer, A. V. Nikitin, V. I. Perevalov, M. Rotger, J. Tennyson, G. C. Toon, H. Tran, V. G. Tyuterev, E. M. Adkins, A. Baker, A. Barbe, E. Canè, A. G. Császár, A. Dudaryonok, O. Egorov, A. J. Fleisher, H. Fleurbaey, A. Foltynowicz, T. Furtenbacher, J. J. Harrison, J.-M. Hartmann, V.-M. Horneman, X. Huang, T. Karman, J. Karns, S. Kassi, I. Kleiner, V. Kofman, F. Kwabia-Tchana, N. N. Lavrentieva, T. J. Lee, D. A. Long, A. A. Lukashevskaya, O. M. Lyulin, V. Yu. Makhnev, W. Matt, S. T. Massie, M. Melosso, S. N. Mikhailenko, D. Mondelain, H. S. P. Müller, O. V. Naumenko, A. Perrin, O. L. Polyansky, E. Raddaoui, P. L. Raston, Z. D. Reed, M. Rey, C. Richard, R. Tobias, I. Sadiek, D. W. Schwenke, E. Starikova, K. Sung, F. Tamassia, S. A. Tashkun, J. Vander Auwera, I. A. Vasilenko, A. A. Vigasin, G. L. Villanueva, B. Vispoel, G. Wagner, A. Yachmenev, and S. N. Yurchenko, “The HITRAN2020 molecular spectroscopic database,” Journal of Quantitative Spectroscopy and Radiative Transfer 277, 107949 (2022).
36. J. Zhang, A. P. Shreenath, M. Kimmel, E. Zeek, R. Trebino, and S. Link, “Measurement of the intensity and phase of attojoule femtosecond light pulses using Optical-Parametric-Amplification Cross-Correlation Frequency-Resolved Optical Gating,” Opt. Express 11, 601-609 (2003).
37. P. M. Vaughan and R. Trebino, “Optical-parametric-amplification imaging of complex objects,” Opt. Express 19, 8920-8929 (2011).
38. E. Mimoun, L. De Sarlo, J.-J. Zondy, J. Dalibard, and F. Gerbier, “Sum-frequency generation of 589 nm light with near-unit efficiency,” Opt. Express 16, 18684 (2008).
39. A. Roy, L. Ledezma, L. Costa, R. Gray, R. Sekine, Q. Guo, M. Liu, R. M. Briggs, and A. Marandi, “Visible-to-mid-IR tunable frequency comb in nanophotonics,” Nat Commun 14, 6549 (2023).
40. U.S. patent application Ser. No. 18/805,408 filed Aug. 14, 2024, entitled “ON-CHIP ULTRA SHORT PULSE SYNTHESIZER” and U.S. patent application Ser. No. 18/662,730, filed May 13, 2024, by Alireza Marandi, Luis. M. Ledezma, Arkadev Roy, Ryoto Sekine, and Robert M. Gray, entitled “THIN FILM SYNCHRONOUSLY PUMPED OPTICAL PARAMETRIC OSCILLATORS.
41. Further information on one or more embodiments of the present invention can be found in https://opg.optica.org/ol/abstract.cfm?uri=ol-49-11-2914 Optics Letters Vol. 49, Issue 11, pp. 2914-2917 (2024) entitled Optical-parametric-amplification-enhanced background-free spectroscopy by Marandi et. al.

### Hardware Environment

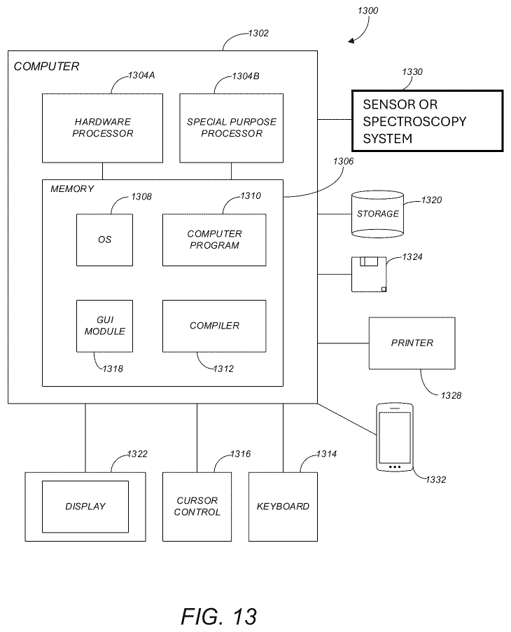

FIG. 13 is an exemplary hardware and software environment 1300 (referred to as a computer-implemented system and/or computer-implemented method) coupled to sensor or spectroscopy system 1330 illustrated in FIG. 1 used to implement one or more embodiments of the invention. The hardware and software environment includes a computer 1302 and may include peripherals. Computer 1302 may be a user/client computer, server computer, or may be a database computer. The computer 1302 comprises a hardware processor 1304A and/or a special purpose hardware processor 1304B (hereinafter alternatively collectively referred to as processor 1304) and a memory 1306, such as random access memory (RAM). The computer 1302 may be coupled to, and/or integrated with, other devices, including input/output (I/O) devices such as a keyboard 1314, a cursor control device 1316 (e.g., a mouse, a pointing device, pen and tablet, touch screen, multi-touch device, etc.) and a printer 1328. In one or more embodiments, computer 1302 may be coupled to, or may comprise, a portable or media viewing/listening device 1332 (e.g., an MP3 player, IPOD, NOOK, portable digital video player, cellular device, personal digital assistant, etc.). In yet another embodiment, the computer 1302 may comprise a multi-touch device, mobile phone, gaming system, internet enabled television, television set top box, or other internet enabled device executing on various platforms and operating systems.

In one embodiment, the computer 1302 operates by the hardware processor 1304A performing instructions defined by the computer program 1310 (e.g., a spectroscopy application) under control of an operating system 1308. The computer program 1310 and/or the operating system 1308 may be stored in the memory 1306 and may interface with the user and/or other devices to accept input and commands and, based on such input and commands and the instructions defined by the computer program 1310 and operating system 1308, to provide output and results.

Output/results may be presented on the display 1322 or provided to another device for presentation or further processing or action. In one embodiment, the display 1322 comprises a liquid crystal display (LCD) having a plurality of separately addressable liquid crystals. Alternatively, the display 1322 may comprise a light emitting diode (LED) display having clusters of red, green and blue diodes driven together to form full-color pixels. Each liquid crystal or pixel of the display 1322 changes to an opaque or translucent state to form a part of the image on the display in response to the data or information generated by the processor 1304 from the application of the instructions of the computer program 1310 and/or operating system 1308 to the input and commands. The image may be provided through a graphical user interface (GUI) module 1318. Although the GUI module 1318 is depicted as a separate module, the instructions performing the GUI functions can be resident or distributed in the operating system 1308, the computer program 1310, or implemented with special purpose memory and processors.

In one or more embodiments, the display 1322 is integrated with/into the computer 1302 and comprises a multi-touch device having a touch sensing surface.

Some or all of the operations performed by the computer 1302 according to the computer program 1310 instructions may be implemented in a special purpose processor 1304B. In this embodiment, some or all of the computer program 1310 instructions may be implemented via firmware instructions stored in a read only memory (ROM), a programmable read only memory (PROM) or flash memory within the special purpose processor 1304B or in memory 1306. The special purpose processor 1304B may also be hardwired through circuit design to perform some or all of the operations to implement the present invention. Further, the special purpose processor 1304B may be a hybrid processor, which includes dedicated circuitry for performing a subset of functions, and other circuits for performing more general functions such as responding to computer program 1310 instructions. In one embodiment, the special purpose processor 1304B is an application specific integrated circuit (ASIC), field programmable gate array, graphics processing unit, processor for implementing neural networks or machine learning or artificial intelligence. The computer 1302 may also implement a compiler 1312 that allows an application or computer program 1310 written in a programming language such as C, C++, Assembly, SQL, PYTHON, PROLOG, MATLAB, RUBY, RAILS, HASKELL, or other language to be translated into processor 1304 readable code. Alternatively, the compiler 1312 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1310 accesses and manipulates data accepted from I/O devices and stored in the memory 1306 of the computer 1302 using the relationships and logic that were generated using the compiler 1312.

The computer 1302 also optionally comprises an external communication device such as a modem, satellite link, Ethernet card, or other device for accepting input from, and providing output to, other computers 1302.

In one embodiment, instructions implementing the operating system 1308, the computer program 1310, and the compiler 1312 are tangibly embodied in a non-transitory computer-readable medium, e.g., data storage device 1320, which could include one or more fixed or removable data storage devices, such as a zip drive, floppy disc drive 1324, hard drive, CD-ROM drive, tape drive, etc. Further, the operating system 1308 and the computer program 1310 are comprised of computer program 1310 instructions which, when accessed, read and executed by the computer 1302, cause the computer 1302 to perform the steps necessary to implement and/or use the present invention or to load the program of instructions into a memory 1306, thus creating a special purpose data structure causing the computer 1302 to operate as a specially programmed computer executing the method steps described herein. Computer program 1310 and/or operating instructions may also be tangibly embodied in memory 1306 and/or data communications devices, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1302.

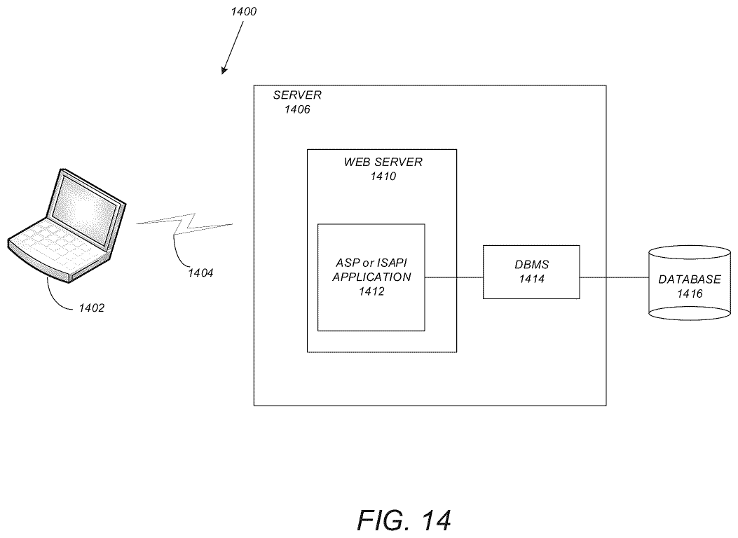

FIG. 14 schematically illustrates a typical distributed/cloud-based computer system 1400 using a network 1404 to connect client computers 1402 to server computers 1406. A typical combination of resources may include a network 1404 comprising the Internet, LANs (local area networks), WANs (wide area networks), SNA (systems network architecture) networks, or the like, clients 1402 that are personal computers or workstations (as set forth in FIG. 13), and servers 1406 that are personal computers, workstations, minicomputers, or mainframes (as set forth in FIG. 13). However, it may be noted that different networks such as a cellular network (e.g., GSM [global system for mobile communications] or otherwise), a satellite based network, or any other type of network may be used to connect clients 1402 and servers 1406 in accordance with embodiments of the invention.

A network 1404 such as the Internet connects clients 1402 to server computers 1406. Network 1404 may utilize ethernet, coaxial cable, wireless communications, radio frequency (RF), etc. to connect and provide the communication between clients 1402 and servers 1406. Further, in a cloud-based computing system, resources (e.g., storage, processors, applications, memory, infrastructure, etc.) in clients 1402 and server computers 1406 may be shared by clients 1402, server computers 1406, and users across one or more networks. Resources may be shared by multiple users and can be dynamically reallocated per demand. In this regard, cloud computing may be referred to as a model for enabling access to a shared pool of configurable computing resources.

Clients 1402 may execute a client application or web browser and communicate with server computers 1406 executing web servers 1410. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1402 may be downloaded from server computer 1406 to client computers 1402 and installed as a plug-in or ACTIVEX control of a web browser. Accordingly, clients 1402 may utilize ACTIVEX components/component object model (COM) or distributed COM (DCOM) components to provide a user interface on a display of client 1402. The web server 1410 is typically a program such as MICROSOFT'S INTERNET INFORMATION SERVER.

Web server 1410 may host an Active Server Page (ASP) or Internet Server Application Programming Interface (ISAPI) application 1412, which may be executing scripts. The scripts invoke objects that execute business logic (referred to as business objects). The business objects then manipulate data in database 1416 through a database management system (DBMS) 1414. Alternatively, database 1416 may be part of, or connected directly to, client 1402 instead of communicating/obtaining the information from database 1416 across network 1404. When a developer encapsulates the business functionality into objects, the system may be referred to as a component object model (COM) system. Accordingly, the scripts executing on web server 1410 (and/or application 1412) invoke COM objects that implement the business logic. Further, server 1406 may utilize MICROSOFT'S TRANSACTION SERVER (MTS) to access required data stored in database 1416 via an interface such as ADO (Active Data Objects), OLE DB (Object Linking and Embedding DataBase), or ODBC (Open DataBase Connectivity).

Generally, these components 1400-1416 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1402 and 1406 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1402 and 1406. Embodiments of the invention are implemented as a software/spectroscopy application on a client 1402 or server computer 1406. Further, as described above, the client 1402 or server computer 1406 may comprise a thin client device or a portable device that has a multi-touch-based display.

### Process Steps

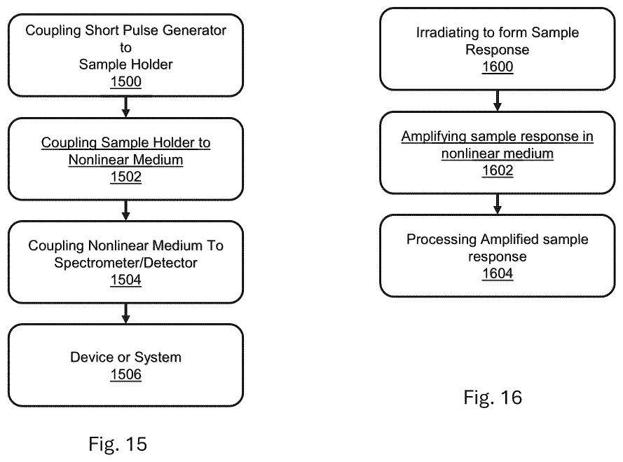

FIG. 15 is a flowchart illustrating a method of making a device or system according to one or more embodiments.

Block 1500 represents coupling a source of short pulses to a sample holder. In one or more examples, the source is a laser, or a laser pumping an optical parametric oscillator comprising a nonlinear medium, e.g., outputting the electromagnetic radiation comprising mid infrared wavelengths.

Block 1502 represent coupling the sample holder to an amplifier comprising a nonlinear medium. In one or more embodiments, the sample holder may be coupled to/in an interferometer.

Block 1504 represents optionally coupling the nonlinear medium to a detector or spectrometer.

Block 1506 represents the end result, a device or system useful for spectroscopy or as a sensor. One or more of the steps 1500-1506 can be implemented using photolithography, e.g., on a lithium niobate substrate, to form an chip or integrated circuit comprising the device and sample holder/container.

The nonlinear medium may comprise a waveguide patterned in a nonlinear material such as lithium niobate. Short (sub nanosecond) pulses typically contain smaller energies in the nanojoule and picojoule range. The waveguides are typically patterned with relatively small (micron or nanoscale cross-sections) to enhance the intensity of the pulses, and thereby increase the efficiency of the second order nonlinear process. In a typical example of a cross-sectional area, the top width W of the cross-section of the waveguide is less than 3 or 5 microns, and the height H of the cross-section of the waveguides (thin film thickness plus etch depth) is less than 1 micron (e.g., in a range of 50-500 nm).

The nonlinear materials in the waveguides are dispersion engineered to control appropriate group velocity dispersion (GVD) of, and group velocity mismatch (GVM) between, pump and signal/idler pulses so as to control temporal overlap/walk off of the pump and signal/idler pulses and/or sample response signals. The dispersion engineering (GVD and GVM) is controlled by tailoring the size of the cross sectional area and/or top width of the waveguides.

Quasi-phase matching (e.g., using periodic poling) of the nonlinear waveguides can be selected for a variety of nonlinear processes. The poling enables phase matching for some frequency components but not others, and the target frequency components can be engineered for example via chirped poling.

Nonlinear media and or photonic integrated circuit can be fabricated on a variety of platforms, e.g., lithium niobate thin film on substrates 130 including, but not limited to, silicon dioxide on silicon, silicon dioxide on bulk lithium niobate, quartz and sapphire, and wherein the nonlinear waveguide comprises periodic poling of the lithium niobate thin film. Other nonlinear materials can be used, however, including doped and un-doped variants of lithium niobate (LN) and lithium tantalate (LT), as well as graphene and III-V materials such as AlN, AlGaN, GaN, GaPN, InGaN, InPN, InN, AlP, AlGaP, AlInP, GaP, AlAs, GaInP, GaAs, InP, InGaP, AlSb, GaSb, InSb, InAs, sapphire, quartz, and various phase matching schemes including quasi-phase matching, birefringent phase matching, and modal phase matching can be considered.

The device or system can be embodied in many ways including, but not limited to, the following (referring also to FIGS. 1-14).

1. A device 100, 101 useful as a spectrometer or a sensor, comprising:
a source 102 of a short electromagnetic pulses 104 at a first wavelength (or comprising a first range of wavelengths or having a first center wavelength of a band of wavelengths) and having a full width at half maximum in a range of 1 femtosecond-1 nanosecond;
a sample holder 106 in which the short pulses interact with the sample in the sample holder so as to form an output signal comprising a background residual 110, 111 of the short pulses and a sample response signal 108, 113 in the time domain,
an amplifier comprising nonlinear medium 114 comprising:
an input 116 for receiving the output signal and a pump pulse 115 at a second wavelength (or comprising a second range of wavelengths or having a center wavelength of a band of wavelengths). The nonlinear medium comprises a second-order nonlinearity configured for a nonlinear process selectively amplifying the sample response signal to form an amplified pulse 116, 117, for example by temporally overlapping the pump pulse and the sample response signal.

2. The device of clause 1 further comprising an interferometer 130 comprising the sample holder 106 and operable to interfere a sign-inverted replica 132/dephased replica of the short pulse (e.g., out of phase with the short pulse, 180 degrees out of phase with the short pulse, or a pi pulse) with the short pulse after interaction with a sample 107 in the sample holder, so as to form the output signal 109 comprising the background residual signal 111 and the sample response signal 113.
3. The device of clause 1 or 2 further comprising a delay path 112 applying a delay between the first wavelength(s) and the second wavelength(s) at the input of the non-linear medium 116, and wherein the amplifier characteristics of the nonlinear medium 116 are designed to amplify the sample response associated with the temporal features of a specific molecular specie in the sample.
4. The device of any of the clauses 1-3 wherein the delay can be adjusted to different values associating with temporal features of different molecular species, and the device either scans the first wavelength and/or the second wavelength to span absorption resonances of the species, for instance through mechanical or electro-optic or dual-comb means, or by discretely selecting wavelengths associated with resonances of different species.
5. The device of any of the clauses 1-4, further comprising a detector 150a coupled to an output of the nonlinear medium, the detector operable to detect an amplified pulse 116 generated by the nonlinear medium and outputting a detection signal in response thereto, which carries information about the molecular species present in the sample.
6. The device of any of the clauses 1-5, further comprising a spectrometer 150b coupled to an output of the nonlinear medium, in which the measured spectrum by the spectrometer carries information about the molecular species present in the sample.
7. A system 1300 comprising the device of clause 5 or 6, further comprising a computer 1302 for determining, from the detection signal or output/measured spectrum, one or more species present in the sample and their concentrations.
8. The system of any of the clauses 1-7, wherein wavelength 1 (first wavelength(s)) is/are selected to overlap with ro-vibrational spectral features (e.g., absorption peaks 200 or dips or lines in an absorption spectrum 202) of one or a plurality of the target molecular species in the sample.
9 The device of any of the clauses 1-8, further comprising a circuit 1302 for controlling the power of the short pulse at the first and/or the second wavelength(s), wherein a minimum detectable absorbance of the sample obtained using the amplified pulse 116, 117 is reduced as compared to that obtained from amplification of both the background residual signa; and the sample response signal.
10. A control circuit 1302 coupled to the device of any of the clauses 1-9, for controlling at least one of a power, a profile, width, center delay of the pump pulse, or a trade-off between a width and peak power of pump pulse for a fixed average power, to tune a minimum detectable absorbance of the sample for predetermined peaks in the absorption spectrum of the sample.
11. A control circuit 1302 coupled to the device of any of the clauses 1-10, for controlling at least one of a power, a profile, a width, center delay of the pump pulse, or a trade-off between a width and peak power of pump pulse for a fixed average power, such that noise in the detection signal is dominated by detector noise and measurement of absorption of the sample from the detector signal is not limited by relative intensity noise of the short pulse.
12. The device of any of the clauses 1-11, wherein the noise of the detector signal and minimum detectable absorbance of the sample obtained using the detector signal are in ranges such that a concentration or a composition differentiation of the sample comprising one or more molecules can be determined from the detection signal.
13. An analyzer comprising the device of clause 5 or 6 or any of the clauses 1-12, wherein the noise and minimum detectable absorbance are configured for identifying composition and/or concentration of molecules in the sample comprising breath, atmospheric pollutants, greenhouse gas, or a process gas monitored in an industrial setting.
14. The device of any of the clauses 1-13, comprising multiple delay paths 112 configured for setting an overlap of the pump pulse and the sample response signal for different absorption peaks/features in the absorption spectrum of the sample.
15. The device of any of the clauses 1-14, wherein the responses of the sample to the short pulse associated with the different absorption features create different delays between the background residual signal and the sample response signal and the delay paths are selected to temporally overlap the pump pulse with each of the different sample response signals.
16. One or more chips or photonic integrated circuits comprising the device of any of the clauses 1-15.
17. The device of any of the clauses 1-16, wherein the nonlinear medium is quasi-phase matched and dispersion engineered for the nonlinear process comprising degenerate or non-degenerate optical parametric amplification (OPA) (including signal up conversion or down conversion).
18. The device of any of the clauses including clause 2, wherein the interferometer comprises:
a first arm (arm 1) comprising the sample holder 106;
a second arm (arm 2) for transmitting the sign-inverted replica/out of phase/dephased replica 132 through an optical path length equivalent to that of the first arm without the sample, the second arm optionally comprising a reference sample holder or cell 133; and
a beamsplitter 134 or coupler coupled to the outputs of the first arm and the second arm for combining the sign inverted replica and the short pulse after the interaction with the sample.
19. The device of any of the clauses 1-18, wherein the sample holder comprises a cavity for confining the sample comprising a gas or a liquid.
20. The device of any of the clauses 1-19, comprising multiple delay paths configured for setting an overlap of the pump pulse and the sample response signal for different absorption peaks in the absorption spectrum of the sample.
21. The device of any of the clauses 1-20, wherein the responses of the sample to the short pulse associated with the different absorption peaks create different delays between the background residual signal and the sample response signal and the delay paths are selected to temporally overlap the pump pulse with each of the different sample response signals.
22. The device of any of the clauses 1-21, wherein the delay path is configured to temporally separate the background residual signal having a timescale similar to the short pulse and the sample response signal having a longer full width and half maximum and/or decay time of at least 1 ps.
23. The device of any of the clauses 1-22, wherein the background residual is a temporal component of the short pulse which is not affected by/absorbed by the sample.
24. The device of any of the clauses 1-22, wherein the first wavelength is a first center wavelength of a first band/range of wavelengths needed for the short pulse and/or the second wavelength is a center frequency of a second band/range of wavelengths, or wherein the first wavelength is a first range or plurality of wavelengths and/or the second wavelength is a second range or plurality of wavelengths.
25. The device of any of the clauses 1-24, wherein the sample response signal is a component that interacts with the sample and is shifted in time with respect to the background residual comprising the component of short pulse that does not interact with the sample.
26. The device of any of the clauses 1-25, wherein the source comprises a laser or laser pumping an optical parametric oscillator (e.g. comprising a nonlinear medium in a cavity or resonator) or nonlinear medium or optical parametric amplifier comprising the nonlinear medium, or arbitrary waveform generator or a short pulse synthesizer, e.g., as described in [40].
27. The device of any of the clauses 1-26, wherein the first wavelengths and/or the second wavelengths are in a range of mid infrared wavelengths, e.g. 1-20 micrometers.
28. The device of any of the clauses 1-27, wherein the nonlinear medium comprises periodically poled lithium niobate.
29. The device of any of the clauses 1-28, wherein the short pulse comprises a first frequency comb and/or the pump pulse comprises a second frequency comb.
30. The device of any of the clauses 1-29, wherein the amplified pulse comprises a signal and/or idler generated in the nonlinear medium via a parametric process and in response to the pump pulse.
31. The device of any of the clauses 1-30, wherein the output signal comprises pulses in the time domain, and wherein the pulses are processed or the signal response is amplified by the amplifier in the time domain rather than looking at a frequency spectrum.
32. The device of any of the clauses 1-31, wherein the delay paths comprise a waveguide having a selected length in a photonic integrated circuit or an optical path (free space optical bath) having a length adjusted using a mirror/beam splitter in a delay line.
33. A method for performing spectroscopy, comprising:
irradiating a sample with short electromagnetic pulses at a first wavelength and having a full width at half maximum in a range of 1 femtosecond-1 nanosecond; to form an output signal comprising a background residual of the short pulses and a sample response signal in the time domain, and
inputting the output signal and a pump pulse at a second wavelength to a nonlinear medium the nonlinear medium comprising a second-order nonlinearity configured for a nonlinear process selectively amplifying the sample response signal.
34. A method of performing spectroscopy, comprising:
irradiating a sample with a short electromagnetic pulse having a full width at half maximum in a range of 1 femtosecond-1 nanosecond;
interfering the short pulse, after interaction with the sample, with a sign inverted replica of the short pulse, to form an interference signal comprising a background residual signal temporally separated from a sample response signal;
setting a delay of a pump pulse relative to the background residual signal;
inputting the interference signal and the pump pulse with the delay to a nonlinear medium having a second order nonlinearity configured for a nonlinear process amplifying the sample response signal to form an amplified pulse when the pump pulse temporally overlaps the sample response signal;
detecting the amplified pulse in a detector outputting a detection signal in response thereto; and
determining one or more absorption peaks/features of the sample from the detection signal.
34. A computer implemented system comprising:
(a) a computer having one or more memories;
(b) one or more processors executing on the computer;
(c) the one or more memories storing a set of instructions, wherein the set of instructions, when executed by the one or more processors cause the one or more processors to perform operations comprising at least one of:
controlling:
timing, duration, and power of a short electromagnetic pulse having a full width at half maximum in a range of 1 femtosecond-1 nanosecond inputted to a sample; and/or
duration and power of a pump pulse with a delay to a nonlinear medium having a second order nonlinearity configured for a nonlinear process amplifying the sample response signal to form an amplified pulse when the pump pulse temporally overlaps the sample response signal;
receiving a detection signal in response to detection of the amplified pulse; and/or
determining one or more absorption features of the sample from the detection signal.
35. A computer comprising a non-transitory computer readable medium storing a plurality of instructions, the plurality of instructions comprising at least one of:
controlling timing, duration, and power of a short electromagnetic pulse having a full width at half maximum in a range of 1 femtosecond-1 nanosecond inputted to a sample;
controlling duration and power of a pump pulse with a delay to a nonlinear medium having a second order nonlinearity configured for a nonlinear process amplifying the sample response signal to form an amplified pulse when the pump pulse temporally overlaps the sample response signal;
receiving a detection signal in response to detection of the amplified pulse: or
determining one or more absorption features of the sample from the detection signal.
36. The method or computer system of any of the clauses 32-35 using, implemented with, controlling, and/or processing the detection signal of, the device or system of any of the clauses 1-31.
37. A device useful as a spectrometer or a sensor, comprising:
a source of a short electromagnetic pulses at the first wavelength having a full width at half maximum in a range of 1 femtosecond-1 nanosecond;
a sample holder in which the pulses interact with the sample so as to form an output signal comprising a background residual from the input pulses and a response signal in the time domain,
a nonlinear medium comprising:
an input for receiving the output signal and a pump pulse at the second wavelength, and
a second-order nonlinearity configured for a nonlinear process selectively amplifying the sample response signal, for example by temporally overlapping the pump pulse and the sample response signal;
38. The device of any of the clauses 1-37 wherein the delay between the wavelength 1 and wavelength 2 at the input of the amplifier, and the amplifier characteristics are designed to amplify the sample response associated with the temporal features of a specific molecular specie.
39. The device of clause 38 wherein the delay can be adjusted to different values associating with temporal features of different molecular species, and the device either scans to cover the species, for instance through mechanical or electro-optic or dual-comb means, or can discretely choose different species.
40. The device of any of the clauses 1-40 further comprising a detector coupled to an output of the nonlinear medium, the detector operable to detect an amplified pulse generated by the amplifier and outputting a detection signal in response thereto, which carries information about the molecular species present in the sample.
41. The device of any of the clauses 1-40, further comprising a spectrometer coupled to an output of the nonlinear medium, in which the measured spectrum by the spectrometer carries information about the molecular species present in the sample.
42. A system comprising the device of clause 40 or 41, further comprising a computer for determining, from the detection signal or output spectrum, one or more species present in the sample and their concentrations.
43. The system of any of the clauses 37-42, wherein wavelength 1 is selected to overlap with ro-vibrational spectral features of one or a plurality of the target molecular species in the sample.
44. The device of any of the clauses 1-43, further comprising a circuit for controlling the power of the short pulse at the first and/or the second wavelength, wherein a minimum detectable absorbance of the sample obtained using the amplified pulse is reduced as compared to that obtained from amplification of both the background residual signal and the sample response signal.
45. The device of any of the clauses 1-44 including clause 2, wherein the interferometer (e.g., a Mach-Zehnder-like or Michelson-like interferometer) arranged for (e.g., destructive) interference is used to coherently subtract the background from the optical field using a sign-inverted replica or appropriately dephased replica.
46. The device of clause 45, wherein the interferometer comprises waveguides and couplers and modulators patterned in a photonic integrated circuit.
47. The device of any of the clauses 1-46 comprising actuators (e.g., electro-optic modulator, an electric heater, a thermo-optical heater, or a piezoelectric transducer, e.g., to modulate phase or amplitude of waves or refractive index of the using electric field or temperature) can be fabricated by depositing metallization coupled to the waveguides formed in the chip.

### Method of Spectroscopy

FIG. 16 illustrates A method for performing spectroscopy, comprising the following steps:

Block 1600 represents irradiating a sample with short electromagnetic pulses at a first wavelength and having a full width at half maximum in a range of 1 femtosecond-1 nanosecond: to form an output signal comprising a background residual of the short pulses and a sample response signal in the time domain. In one or more embodiments, the step comprises interfering the short pulse, after interaction with the sample, with a sign inverted replica of the short pulse, to form an interference signal comprising a background residual signal temporally separated from a sample response signal,

In one or more embodiments, the step comprises controlling timing, duration, and power of a short electromagnetic pulse having a full width at half maximum in a range of 1 femtosecond-1 nanosecond inputted to a sample.

Block 1602 represents inputting the output signal and the pump pulse at a second wavelength to a nonlinear medium the nonlinear medium comprising a second-order nonlinearity configured for a nonlinear process selectively amplifying the sample response signal.

In one or more embodiments, the step comprises controlling duration and power of a pump pulse with a delay to a nonlinear medium having a second order nonlinearity configured for a nonlinear process amplifying the sample response signal to form an amplified pulse when the pump pulse temporally overlaps the sample response signal.

In one or more embodiments, the step comprises setting a delay of a pump pulse relative to the background residual signal.

Block 1604 represents processing or analyzing the amplified signal to determine information about the sample. In one or more embodiments, the step comprise detecting the amplified pulse in a detector outputting a detection signal in response thereto; and determining one or more absorption peaks/features of the sample from the detection signal. The method can be implemented using the device of any of the embodiments 1-47.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A device useful as a spectrometer or a sensor, comprising:
a source of a short electromagnetic pulses at a first wavelength and having a full width at half maximum in a range of 1 femtosecond-1 nanosecond;
a sample holder in which the short pulses interact with the sample in the sample holder so as to form an output signal comprising a background residual of the short pulses and a sample response signal in the time domain,
an amplifier comprising nonlinear medium comprising:
an input for receiving the output signal and a pump pulse at a second wavelength, and
a second-order nonlinearity configured for a nonlinear process selectively amplifying the sample response signal to form an amplified pulse or signal.

2. The device of claim 1 further comprising an interferometer comprising the sample holder and operable to interfere a sign-inverted replica or out of phase replica of the short pulse with the short pulse after interaction with the sample in the sample holder, so as to form the output signal comprising the background residual and the sample response signal.

3. The device of claim 1 further comprising a delay path applying a delay between the first wavelength and the second wavelength at the input of the non-linear medium, and wherein the amplifier characteristics of the nonlinear medium are designed to amplify the sample response signal associated with the temporal features of a specific molecular specie in the sample.

4. The device of claim 3 wherein the delay can be adjusted to different values associated with temporal features of different molecular species in the sample, and the device either scans the first wavelength and/or the second wavelength to span absorption resonances of the species or discretely selects wavelengths associated with the resonances of different ones of the species.

5. The device of claim 1, further comprising a detector coupled to an output of the nonlinear medium, the detector operable to detect the amplified pulse generated by the nonlinear medium and outputting a detection signal in response thereto, wherein the detection signal carries information about the molecular species present in the sample.

6. The device of claim 5, further comprising a spectrometer coupled to an output of the nonlinear medium, in which a measured spectrum of the amplified pulse by the spectrometer carries information about the molecular species present in the sample.

7. A system comprising the device of claim 1, further comprising a computer configured for determining, from a detection signal outputted from a detector in response to the amplified pulse, or an output spectrum of the amplified pulse measured by a spectrometer, one or more species present in the sample and their concentrations.

8. The system of claim 1, wherein the first wavelength is selected to overlap with ro-vibrational spectral features of one or a plurality of the target molecular species in the sample.

9. The device of claim 1, further comprising a circuit for controlling the power of the short pulse at the first and/or the second wavelength, wherein a minimum detectable absorbance of the sample obtained using the amplified pulse is reduced as compared to that obtained from amplification of both the background residual signal and the sample response signal.

10. A control circuit coupled to the device of claim 1, for controlling at least one of a power, a profile, a width, center delay of the pump pulse, or a trade-off between a width and peak power of pump pulse for a fixed average power, to tune a minimum detectable absorbance of the sample for predetermined features in an absorption spectrum of the sample.

11. A control circuit coupled to the device of claim 1, for controlling at least one of a power, a profile, a width, center delay of the pump pulse, or a trade-off between a width and peak power of pump pulse for a fixed average power, such that noise in a detection signal of the amplified pulse by a detector is dominated by detector noise and measurement of absorption of the sample from the detector signal is not limited by relative intensity noise of the short pulse.

12. The device of claim 1, wherein noise of a detector signal outputted from a detector detecting the amplified pulse and minimum detectable absorbance of the sample obtained using the detector signal are in ranges such that a concentration or a composition differentiation of the sample comprising one or more molecules can be determined from the detection signal.

13. An analyzer comprising the device of claim 1, wherein the noise and minimum detectable absorbance are configured for identifying composition and/or concentration of molecules in the sample comprising breath, atmospheric pollutants, greenhouse gas, or a process gas monitored in an industrial setting.

14. The device of claim 1, comprising multiple delay paths configured for setting an overlap of the pump pulse and the sample response signal for different absorption peaks or features in a absorption spectrum of the sample.

15. The device of claim 1, wherein the sample response signals of the sample to the short pulse associated with different absorption features create different delays between the background residual signal and the sample response signals and delays between the between the first wavelength and the second wavelength are selected to temporally overlap the pump pulse with each of the different sample response signals.

16. One or more chips or photonic integrated circuits comprising the device of claim 1.

17. The device of claim 1, wherein the nonlinear medium is quasi-phase matched for the nonlinear process comprising degenerate or non-degenerate optical parametric amplification (OPA).

18. The device of claim 2, wherein the interferometer comprises:
a first arm comprising the sample holder;
a second arm for transmitting a sign-inverted or dephased replica of the short pulse through an optical path length equivalent to that of the first arm without the sample; and
a beamsplitter or coupler coupled to the outputs of the first arm and the second arm for combining the replica and the short pulse after the interaction with the sample.

19. The device of claim 1, wherein the sample holder comprises a cavity for confining the sample comprising a gas or a liquid.

20. A method for performing spectroscopy, comprising:
irradiating a sample with short electromagnetic pulses at a first wavelength and having a full width at half maximum in a range of 1 femtosecond-1 nanosecond: to form an output signal comprising a background residual of the short pulses and a sample response signal in the time domain, and
inputting the output signal and a pump pulse at a second wavelength to a nonlinear medium comprising a second-order nonlinearity configured for a nonlinear process selectively amplifying the sample response signal to form an amplified signal; and
analyzing the amplified signal to determine information about the sample.
